(19) United States
(12) Patent Application Publication
(10) Pub. No.: US 2026/0362256 A1
(43) Pub. Date: Nov. 12, 2026

(54) EARLY-SYNCHRONIZATION TECHNIQUES FOR LAYER 3 HANDOVER PROCEDURES

(71) Applicant: QUALCOMM Incorporated, San Diego, CA (US)

(72) Inventors: Toru UCHINO, Zushi-shi (JP); Shankar KRISHNAN, Poway, CA (US); Doohyun SUNG, Basking Ridge, NJ (US); Prasada Veera Reddy KADIRI, San Diego, CA (US); Jelena DAMNJANOVIC, Del Mar, CA (US)

(21) Appl. No.: 19/203,099

(22) Filed: May 8, 2025

(51) Int. Cl. H04W 36/00

(52) U.S. Cl. CPC H04W 36/0072; H04W 36/0058; H04W 36/0077

(57) ABSTRACT

This disclosure provides methods, components, devices and systems for early-synchronization techniques for Layer 3 (L3) handover procedures. For example, a UE may transmit measurement reports to a serving cell (e.g., serving node), where the measurement reports include measurements associated with a candidate cell (e.g., candidate node). The serving cell may request early synchronization information from the candidate cell, and may provide the early synchronization information to the UE via a first L3 message. The UE may use the early synchronization information to communicate with the candidate cell (prior to performing a handover with the candidate cell). Subsequently, the serving cell may transmit a second L3 message (e.g., RRC reconfiguration message) that includes a handover command to instruct the UE to perform a handover procedure from the serving cell to the candidate cell.

### TECHNICAL FIELD

This disclosure relates generally to wireless communication, and more specifically to systems, devices, and methods associated with early-synchronization techniques for Layer 3 (L3) handover procedures.

### DESCRIPTION OF THE RELATED TECHNOLOGY

Communication systems are deployed to provide communication services such as voice, video, packet data, messaging, or broadcast, among others. A communication system may include a wireless communication network (such as a radio access network (RAN)) that supports communication between wireless communication devices such as network entities (such as base stations), client devices (such as one or more user equipments (UEs)), and others. Such devices may communicate with one another using a variety of protocols (such as radio access technologies (RATs)), including those of cellular-based systems such as fourth generation (4G) systems (such as Long Term Evolution (LTE) systems), fifth generation (5G) systems (such as 5G New Radio (5G-NR) systems), and sixth generation (6G) systems. A wireless communication network may support communication by implementing system resources (such as frequency resources, time resources, spatial resources) in accordance with a wireless communication protocol.

### SUMMARY

The systems, methods, and devices of this disclosure each have several innovative aspects, no single one of which is solely responsible for the desirable attributes disclosed herein. The following is a summary of some non-limiting aspects of the disclosure:

A method by a user equipment (UE) is described. The method may include receiving, from a serving cell, a first layer three (L3) message including early synchronization information for a candidate cell, the early synchronization information including a random access configuration for communications with the candidate cell, a radio resource control (RRC) configuration for the candidate cell, a transmission configuration indicator (TCI) state for communications with the candidate cell, or any combination thereof, communicating with the candidate cell in accordance with the early synchronization information, receiving, based on communicating with the candidate cell in accordance with the early synchronization information, a second L3 message including a handover command for the UE to perform a handover procedure from the serving cell to the candidate cell, the second L3 message further including a target cell configuration for communicating with the candidate cell, and performing the handover procedure from the serving cell to the candidate cell in response to the second L3 message and in accordance with the target cell configuration.

A UE is described. The UE may include a processing system that includes processor circuitry and memory circuitry that stores code. The processing system may be configured to cause the UE to receive, from a serving cell, a first L3 message including early synchronization information for a candidate cell, the early synchronization information including a random access configuration for communications with the candidate cell, a RRC configuration for the candidate cell, a TCI state for communications with the candidate cell, or any combination thereof, communicate with the candidate cell in accordance with the early synchronization information, receive, based on communicating with the candidate cell in accordance with the early synchronization information, a second L3 message including a handover command for the UE to perform a handover procedure from the serving cell to the candidate cell, the second L3 message further including a target cell configuration for communicating with the candidate cell, and perform the handover procedure from the serving cell to the candidate cell in response to the second L3 message and in accordance with the target cell configuration.

Another UE is described. The UE may include means for receiving, from a serving cell, a first L3 message including early synchronization information for a candidate cell, the early synchronization information including a random access configuration for communications with the candidate cell, a RRC configuration for the candidate cell, a TCI state for communications with the candidate cell, or any combination thereof, means for communicating with the candidate cell in accordance with the early synchronization information, means for receiving, based on communicating with the candidate cell in accordance with the early synchronization information, a second L3 message including a handover command for the UE to perform a handover procedure from the serving cell to the candidate cell, the second L3 message further including a target cell configuration for communicating with the candidate cell, and means for performing the handover procedure from the serving cell to the candidate cell in response to the second L3 message and in accordance with the target cell configuration.

A non-transitory computer-readable medium storing code is described. The code may include instructions executable by one or more processors to receive, from a serving cell, a first L3 message including early synchronization information for a candidate cell, the early synchronization information including a random access configuration for communications with the candidate cell, a RRC configuration for the candidate cell, a TCI state for communications with the candidate cell, or any combination thereof, communicate with the candidate cell in accordance with the early synchronization information, receive, based on communicating with the candidate cell in accordance with the early synchronization information, a second L3 message including a handover command for the UE to perform a handover procedure from the serving cell to the candidate cell, the second L3 message further including a target cell configuration for communicating with the candidate cell, and perform the handover procedure from the serving cell to the candidate cell in response to the second L3 message and in accordance with the target cell configuration.

In some examples of the method, UEs, and non-transitory computer-readable medium described herein, the target cell configuration includes a random access configuration, a configured grant, or both, that indicates a set of resources for communicating with the candidate cell and performing the handover procedure from the serving cell to the candidate cell includes communicating with the candidate cell via the set of resources.

In some examples of the method, UEs, and non-transitory computer-readable medium described herein, communicating with the candidate cell in accordance with the early synchronization information may include operations, features, means, or instructions for performing a random access procedure with the candidate cell in accordance with the early synchronization information and prior to receiving the handover command.

Some examples of the method, UEs, and non-transitory computer-readable medium described herein may further include operations, features, means, or instructions for performing one or more measurements for signals received from the candidate cell based on communicating with the candidate cell in accordance with the early synchronization information and transmitting, to the serving cell, a measurement report indicating the one or more measurements, where the second L3 message may be received based on transmitting the measurement report.

In some examples of the method, UEs, and non-transitory computer-readable medium described herein, communicating with the candidate cell in accordance with the early synchronization information may include operations, features, means, or instructions for receiving, from the candidate cell, a timing advance (TA) value for communicating with the candidate cell and communicating with the candidate cell in accordance with the TA value and based on performing the handover procedure.

Some examples of the method, UEs, and non-transitory computer-readable medium described herein may further include operations, features, means, or instructions for determining a first downlink timing value for the candidate cell based on communicating with the candidate cell in accordance with the early synchronization information, determining a TA value for the candidate cell based on the first downlink timing value for the candidate cell, a second downlink timing value for the serving cell, and an uplink timing value for the serving cell, and communicating with the candidate cell in accordance with the TA value and based on performing the handover procedure.

Some examples of the method, UEs, and non-transitory computer-readable medium described herein may further include operations, features, means, or instructions for receiving an indication of a TA value for the candidate cell via the second L3 message and communicating with the candidate cell in accordance with the TA value and based on performing the handover procedure.

Some examples of the method, UEs, and non-transitory computer-readable medium described herein may further include operations, features, means, or instructions for receiving a first indication of a TA value for the candidate cell via the first L3 message, receiving a second indication of the TA value for the candidate cell via the second L3 message, determining the TA value to use for communications with the candidate cell based on the first indication of the TA value, the second indication of the TA value, or both, and communicating with the candidate cell in accordance with the determined TA value and based on performing the handover procedure.

A method by a serving cell is described. The method may include obtaining, from a candidate cell, a message indicating early synchronization information for the candidate cell, the early synchronization information including a random access configuration for communications with the candidate cell, a RRC configuration for the candidate cell, a TCI state for communications with the candidate cell, or any combination thereof, outputting, to a UE, a first L3 message including the early synchronization information, and outputting, to the UE, a second L3 message including a handover command for the UE to perform a handover procedure from the serving cell to the candidate cell, the second L3 message further including a target cell configuration for communicating with the candidate cell.

A serving cell is described. The serving cell may include a processing system that includes processor circuitry and memory circuitry that stores code. The processing system may be configured to cause the serving cell to obtain, from a candidate cell, a message indicating early synchronization information for the candidate cell, the early synchronization information including a random access configuration for communications with the candidate cell, a RRC configuration for the candidate cell, a TCI state for communications with the candidate cell, or any combination thereof, output, to a UE, a first L3 message including the early synchronization information, and output, to the UE, a second L3 message including a handover command for the UE to perform a handover procedure from the serving cell to the candidate cell, the second L3 message further including a target cell configuration for communicating with the candidate cell.

Another serving cell is described. The serving cell may include means for obtaining, from a candidate cell, a message indicating early synchronization information for the candidate cell, the early synchronization information including a random access configuration for communications with the candidate cell, a RRC configuration for the candidate cell, a TCI state for communications with the candidate cell, or any combination thereof, means for outputting, to a UE, a first L3 message including the early synchronization information, and means for outputting, to the UE, a second L3 message including a handover command for the UE to perform a handover procedure from the serving cell to the candidate cell, the second L3 message further including a target cell configuration for communicating with the candidate cell.

A non-transitory computer-readable medium storing code is described. The code may include instructions executable by one or more processors to obtain, from a candidate cell, a message indicating early synchronization information for the candidate cell, the early synchronization information including a random access configuration for communications with the candidate cell, a RRC configuration for the candidate cell, a TCI state for communications with the candidate cell, or any combination thereof, output, to a UE, a first L3 message including the early synchronization information, and output, to the UE, a second L3 message including a handover command for the UE to perform a handover procedure from the serving cell to the candidate cell, the second L3 message further including a target cell configuration for communicating with the candidate cell.

Some examples of the method, serving cells, and non-transitory computer-readable medium described herein may further include operations, features, means, or instructions for outputting a handover request message to the candidate cell, the handover request message including a request for the early synchronization information, where the message indicating the early synchronization information may be obtained in response to the handover request message.

Some examples of the method, serving cells, and non-transitory computer-readable medium described herein may further include operations, features, means, or instructions for outputting, via the handover request message, a second request for the target cell configuration and obtaining a second message indicating the target cell configuration from the candidate cell in response to the second request, where the first L3 message may be outputted based on obtaining the message indicating early synchronization information, the second message indicating the target cell configuration, or both, from the candidate cell.

Some examples of the method, serving cells, and non-transitory computer-readable medium described herein may further include operations, features, means, or instructions for outputting, to the candidate cell, a configuration update request for updating the target cell configuration and obtaining, from the candidate cell in response to the configuration update request, a configuration update for updating the target cell configuration for the candidate cell, where the second L3 message including the target cell configuration may be outputted based on obtaining the configuration update.

In some examples of the method, serving cells, and non-transitory computer-readable medium described herein, the target cell configuration includes a random access configuration, a configured grant, or both, that indicates a set of resources for communicating with the candidate cell.

Some examples of the method, serving cells, and non-transitory computer-readable medium described herein may further include operations, features, means, or instructions for outputting, to the UE, an indication of a TA value for the candidate cell via the second L3 message.

Some examples of the method, serving cells, and non-transitory computer-readable medium described herein may further include operations, features, means, or instructions for obtaining the TA value for the candidate cell from the candidate cell, where the indication of the TA value may be outputted to the UE based on obtaining the TA value from the candidate cell.

Some examples of the method, serving cells, and non-transitory computer-readable medium described herein may further include operations, features, means, or instructions for obtaining a default TA value for the candidate cell via the message from the candidate cell, obtaining, from the candidate cell and based on outputting the first L3 message, an update to the default TA value, and outputting, to the UE, an indication of a TA value for the candidate cell based on obtaining the update from the candidate cell.

A method by a serving cell is described. The method may include outputting, to a candidate cell, a first request for early synchronization information for the candidate cell, obtaining, from the candidate cell in response to the first request, a first message indicating the early synchronization information for the candidate cell, the early synchronization information including a random access configuration for communications with the candidate cell, a RRC configuration for the candidate cell, a TCI state for communications with the candidate cell, or any combination thereof, outputting, to a UE, a first L3 message including the early synchronization information, outputting, to the candidate cell, a second request for a target cell configuration for communications with the candidate cell, obtaining, from the candidate cell in response to the second request, a second message indicating the target cell configuration for the candidate cell, and outputting, to the UE, a second L3 message including a handover command for the UE to perform a handover procedure from the serving cell to the candidate cell, the second L3 message further including the target cell configuration for communicating with the candidate cell.

A serving cell is described. The serving cell may include a processing system that includes processor circuitry and memory circuitry that stores code. The processing system may be configured to cause the serving cell to output, to a candidate cell, a first request for early synchronization information for the candidate cell, obtain, from the candidate cell in response to the first request, a first message indicating the early synchronization information for the candidate cell, the early synchronization information including a random access configuration for communications with the candidate cell, a RRC configuration for the candidate cell, a TCI state for communications with the candidate cell, or any combination thereof, output, to a UE, a first L3 message including the early synchronization information, output, to the candidate cell, a second request for a target cell configuration for communications with the candidate cell, obtain, from the candidate cell in response to the second request, a second message indicating the target cell configuration for the candidate cell, and output, to the UE, a second L3 message including a handover command for the UE to perform a handover procedure from the serving cell to the candidate cell, the second L3 message further including the target cell configuration for communicating with the candidate cell.

Another serving cell is described. The serving cell may include means for outputting, to a candidate cell, a first request for early synchronization information for the candidate cell, means for obtaining, from the candidate cell in response to the first request, a first message indicating the early synchronization information for the candidate cell, the early synchronization information including a random access configuration for communications with the candidate cell, a RRC configuration for the candidate cell, a TCI state for communications with the candidate cell, or any combination thereof, means for outputting, to a UE, a first L3 message including the early synchronization information, means for outputting, to the candidate cell, a second request for a target cell configuration for communications with the candidate cell, means for obtaining, from the candidate cell in response to the second request, a second message indicating the target cell configuration for the candidate cell, and means for outputting, to the UE, a second L3 message including a handover command for the UE to perform a handover procedure from the serving cell to the candidate cell, the second L3 message further including the target cell configuration for communicating with the candidate cell.

A non-transitory computer-readable medium storing code is described. The code may include instructions executable by one or more processors to output, to a candidate cell, a first request for early synchronization information for the candidate cell, obtain, from the candidate cell in response to the first request, a first message indicating the early synchronization information for the candidate cell, the early synchronization information including a random access configuration for communications with the candidate cell, a RRC configuration for the candidate cell, a TCI state for communications with the candidate cell, or any combination thereof, output, to a UE, a first L3 message including the early synchronization information, output, to the candidate cell, a second request for a target cell configuration for communications with the candidate cell, obtain, from the candidate cell in response to the second request, a second message indicating the target cell configuration for the candidate cell, and output, to the UE, a second L3 message including a handover command for the UE to perform a handover procedure from the serving cell to the candidate cell, the second L3 message further including the target cell configuration for communicating with the candidate cell.

In some examples of the method, serving cells, and non-transitory computer-readable medium described herein, the target cell configuration includes a random access configuration, a configured grant, or both, that indicates a set of resources for communicating with the candidate cell.

Some examples of the method, serving cells, and non-transitory computer-readable medium described herein may further include operations, features, means, or instructions for outputting, to the UE, an indication of a TA value for the candidate cell via the second L3 message.

Some examples of the method, serving cells, and non-transitory computer-readable medium described herein may further include operations, features, means, or instructions for obtaining the TA value for the candidate cell from the candidate cell, where the indication of the TA value may be outputted to the UE based on obtaining the TA value from the candidate cell.

### BRIEF DESCRIPTION OF THE DRAWINGS

FIG. 1 shows an example of a wireless communication system.

FIG. 2 shows an example of a signaling configuration that supports early-synchronization techniques for Layer 3 (L3) handover procedures.

FIG. 3 shows an example of a process flow that supports early-synchronization techniques for L3 handover procedures.

FIG. 4 shows an example of a process flow that supports early-synchronization techniques for L3 handover procedures.

FIG. 5 shows an example of a process flow that supports early-synchronization techniques for L3 handover procedures.

FIG. 6 shows an example of a process flow that supports early-synchronization techniques for L3 handover procedures.

FIG. 7 shows an example of a process flow that supports early-synchronization techniques for L3 handover procedures.

FIG. 8 shows an example of a process flow that supports early-synchronization techniques for L3 handover procedures.

FIG. 9 shows an example of a process flow that supports early-synchronization techniques for L3 handover procedures.

FIG. 10 shows a block diagram of a processing system that supports early-synchronization techniques for L3 handover procedures.

FIG. 11 shows a diagram of a system including a device that supports early-synchronization techniques for L3 handover procedures.

FIG. 12 shows a block diagram of a processing system that supports early-synchronization techniques for L3 handover procedures.

FIG. 13 shows a diagram of a system including a device that supports early-synchronization techniques for L3 handover procedures.

FIGS. 14 through 16 show flowcharts illustrating methods that support early-synchronization techniques for L3 handover procedures.

Details of aspects and advantages of the subject matter in this disclosure are set forth in the drawings and accompanying descriptions. Like reference numbers and designations in the various drawings indicate like elements.

### DETAILED DESCRIPTION

A communication system may include a radio access network (RAN) that supports wireless communication. Communication of a RAN may be performed in accordance with one or more radio access technologies (RATs), including 4G, 5G, or 6G, among others, including technologies not explicitly mentioned herein. A RAT may employ access technologies (such as multiplexing technologies) including code division multiple access (CDMA), time division multiple access (TDMA), frequency division multiple access (FDMA), orthogonal FDMA (OFDMA), single-carrier FDMA (SC-FDMA), time division synchronous code division multiple access (TD-SCDMA), or discrete Fourier transform spread orthogonal frequency division multiplexing (DFT-S-OFDM), among others. A RAT may support one or more service types, including machine type communication (MTC), massive MTC (mMTC), Internet of Things (IoT), narrowband IoT (NB-IoT), reduced capability (RedCap), enhanced mobile broadband (eMBB), ultra-reliable low-latency communication (URLLC), or public safety, among others.

To support these and other target verticals, a communication system (such as a RAN) may be designed to implement one or more of a modularized functional infrastructure, a disaggregated and service-based network architecture, network function virtualization, network slicing, multi-access edge computing, spatial processing or multipath techniques, IoT or RedCap device connectivity and management, industrial connectivity, licensed and unlicensed spectrum access, sidelink or other device-to-device (D2D) direct communication (such as vehicle-to-everything (V2X)), frequency spectrum expansion, overlapping spectrum use, small cell deployments, non-terrestrial network (NTN) deployments, device aggregation, advanced duplex communication (such as sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases such as voice calls, messaging, data transfer, streaming, wireless data centers, extended reality (XR) and metaverse applications, vehicle connectivity, holographic and mixed reality communication, autonomous and collaborative robots, sensing networks, gesture monitoring, human-brain interfacing, digital twin applications, asset management, and universal coverage using non-terrestrial or aerial platforms, among other examples. As the demand for connectivity continues to increase, further improvements may be implemented, and other RATs, including 6G and beyond, may be introduced to enable new applications and use cases. The systems, methods, and devices described herein may enable one or more of the foregoing technologies or new technologies or support one or more of the foregoing use cases or new use cases.

In some wireless communication systems, a user equipment (UE) may handover from one cell (e.g., a source cell, or serving cell) to another cell (e.g., a target cell, or candidate cell) according to a handover procedure. The network may use different types of signaling to trigger handover procedures, including Layer 1 (L1), Layer 2 (L2), and Layer 3 (L3) signaling. Performance of handover procedures using L1 and L2 signaling may collectively be referred to as lower-layer triggered mobility (LTM). With traditional LTM, a UE may be configured to communicate information with a candidate cell before actually being handed over to the candidate cell. This “early synchronization” with the candidate cell may be used to obtain information for communicating with the candidate cell, and may therefore reduce a latency of communications between the UE and the candidate cell once the UE is actually handed over to the candidate cell. However, current wireless networks do not support any similar “early synchronization” for L3-triggered handovers.

For the purposes of the present disclosure, a “cell” (e.g., serving cell, candidate cell, neighboring cell, etc.) may be associated with or otherwise supported by one or more base stations, network entities, network nodes, etc. For example, a “serving cell” may be associated with or otherwise supported by a “serving node,” and a “candidate cell” may be associated with or otherwise supported by a “candidate node.” In some cases, a single network entity/network node may support one (or multiple) cells. Therefore, for the purposes of the present disclosure, any description herein describing communications performed by or with a “cell” may additionally or alternatively be understood to refer to communications performed by or with a network entity/network node that supports the respective cell.

Aspects of the subject matter described in this disclosure relate to techniques for early synchronization for L3 handover procedures. Aspects of the present disclosure support signaling and configurations that enable a UE to obtain early synchronization information for a candidate cell before being handed over to the candidate cell via L3 signaling. For example, a UE may transmit measurement reports to a serving cell, where the measurement reports include information associated with candidate cells and are used by the serving cell to make handover decisions for the UE. In this example, the serving cell may request early synchronization information (e.g., transmission configuration indicator (TCI) state information, a radio resource control (RRC) configuration, a random access channel (RACH) configuration, etc.) from the candidate cell, and may provide the early synchronization information to the UE via a first L3 message (e.g., RRC reconfiguration message). The UE may use the early synchronization information to communicate with the candidate cell (prior to performing a handover with the candidate cell). Subsequently, the serving cell may transmit a second L3 message (e.g., RRC reconfiguration message) that includes a handover command to instruct the UE to perform a handover procedure from the serving cell to the candidate cell. In some aspects, the first and/or second L3 message may include a target cell configuration for communicating with the candidate cell. Subsequently, the UE may perform the handover procedure and may communicate with the candidate cell using the target cell configuration.

Particular aspects of the subject matter described in this disclosure can be implemented to realize one or more of the following potential advantages. In some examples, by obtaining early synchronization information and target configuration information of a candidate cell, the described techniques can be used to reduce latency associated with a handover to the candidate cell. That is, by communicating early synchronization information for the candidate cell to the UE prior to handover, there may be less information for the UE to acquire or obtain after being handed over to the candidate cell, thereby facilitating earlier communications between the UE and the candidate cell.

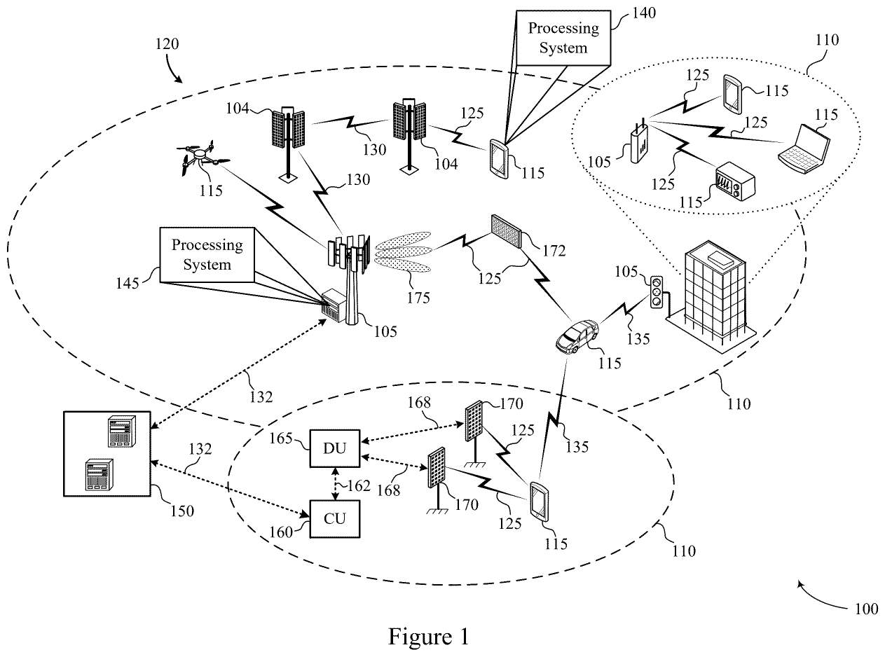

FIG. 1 shows an example of a wireless communication system 100. The wireless communication system 100 includes a core network 150 and a RAN 120 that support communication with one or more devices, such as UEs 115. A RAN 120 may include one or more network entities 105 configured to support wireless communication with the UEs 115.

The wireless communication system 100 may support communication among network entities 105 and UEs 115 in accordance with a layered protocol stack. For example, in a user plane, communication at a bearer layer, a Packet Data Convergence Protocol (PDCP) layer, or Service Data Adaption Protocol (SDAP) layer may be Internet Protocol (IP)-based. A Radio Link Control (RLC) layer may perform packet segmentation and reassembly to communicate via logical channels. A Medium Access Control (MAC) layer may perform priority handling and multiplexing of logical channels into transport channels. A MAC layer also may implement error detection techniques, error correction techniques, or retransmissions. In a control plane, a RRC (RRC) layer may provide establishment, configuration, and maintenance of an RRC connection between UEs 115 and a network entity 105 or a core network 150, supporting radio bearers for user plane data. A Physical (PHY) layer may map transport channels to physical channels.

A core network 150 may support user authentication, access authorization, tracking, IP connectivity, and other access, routing, or mobility functions (such as via network entities 105). A core network 150 may be a 5G core (5GC) or 6G core (6GC), and may include at least one control plane entity that manages access and mobility and at least one user plane entity that routes packets or interconnects to external networks (such as a serving gateway (S-GW), a Packet Data Network (PDN) gateway (P-GW), a user plane function (UPF)).

A network entity 105 may support wireless communication in accordance with one or more coverage areas 110, and may be referred to as a network element, a network node, a RAN node, or network equipment, among other nomenclature. One or more of the network entities 105 may include or may be referred to as a base station. Depending on its capabilities, a base station may be referred to as a NodeB, an eNodeB (eNB), a next-generation NodeB or giga-NodeB (either of which may be referred to as a gNB), a 5G NB, a 6G NB, a next-generation eNB (ng-eNB), a Home NodeB, a Home eNodeB, or other suitable terminology. The wireless communication system 100 may include a heterogeneous network in which different types of network entities 105 support communication for one or more coverage areas 110 using the same or different RATs.

In some examples, a network entity 105 may be implemented in an aggregated (such as monolithic, standalone) architecture, which may utilize a protocol stack that is physically or logically integrated within one network entity 105 (such as a single physical RAN node). In some other examples, a network entity 105 may be implemented in a disaggregated architecture, which may utilize a protocol stack that is physically or logically distributed among multiple network entities 105, including in an integrated access and backhaul (IAB) network, an open RAN (O-RAN), or a virtualized RAN (vRAN). In a disaggregated architecture, a network entity 105 may include or be referred to as one or more of a central unit (CU) (such as CU 160), a distributed unit (DU) (such as DU 165), a radio unit (RU) (such as RU 170), or a combination thereof. The wireless communication system 100 may also implement a service-based architecture that provides a modular framework in which control plane functionality and common data repositories may be delivered through a set of interconnected network functions (NFs) that may access services of other NFs.

UEs 115 may be located in a coverage area 110 of one or more network entities 105, and may include or be referred to as an access terminal, a mobile station, a client device, or a subscriber unit. A UE 115 may be, include, or be coupled with a cellular phone, a wireless modem, a tablet device, a laptop computer, a wireless local loop (WLL) station, a camera, a medical or biometric device, a wearable device, a gaming device, an entertainment device, an XR device, a vehicular component or sensor, a smart meter or sensor, industrial manufacturing equipment, a Global Positioning System (GPS) or other positioning device, a robot or other device implementing artificial intelligence, a UE function of a network node, or any other wireless communication device or function that may communicate using a wireless medium.

The wireless communication system 100 may support various types of communication links among devices. For example, wireless communication between a network entity 105 and a UE 115 may be supported using one or more of a communication link 125 (such as a Uu interface), which may include downlink communication from a network entity 105 to a UE 115, uplink communication from a UE 115 to a network entity 105, or both. Direct wireless communication between UEs 115 may be supported using a communication link 135 (such as a device-to-device (D2D) communication link, a sidelink, a PC5 interface).

Communication between a network entity 105 and a core network 150 may be supported using a backhaul link 132 (such as an S1, N2, N3, NG, or other interface). In some implementations, communication between network entities 105 may be supported using a backhaul link 132 (such as an X2, Xn, or other interface) either directly (such as directly between network entities 105) or indirectly (such as via a core network 150). In some implementations (such as in a disaggregated architecture), communication between a CU 160 and a DU 165 may be supported using a midhaul link 162, and communication between a DU 165 and an RU may be supported using a fronthaul link 168. A backhaul link 132, a midhaul link 162, a fronthaul link 168, or any combination thereof may be or include one or more wired links (such as an electrical link, an optical fiber link) or one or more wireless links (such as a radio link, a wireless optical link), among other examples or combinations thereof. Wireless backhaul, midhaul, or fronthaul may be implemented via one or more IAB nodes 104, which may act as a relay using resources of an IAB donor network entity 105 (such as via a wireless link 130).

The wireless communication system 100 may include one or more of a relay 172 that may steer or reflect signals transmitted by other entities, which may support any of the described communication links. A relay 172 may include active elements or passive elements, and may be in the form of a reconfigurable intelligent surface (RIS). An RIS may include tunable reflecting antenna arrays or metasurfaces, which may be used to enhance coverage or efficiency in multipath environments.

Network entities 105 and UEs 115 each may include one or multiple antennas. Multiple antennas of such devices may be used to employ techniques such as transmit diversity, receive diversity, MIMO communication, or beamforming, and may be organized or structured as one or more antenna panels, one or more antenna groups, one or more sets of antenna elements, or one or more antenna arrays, among other examples. As used herein, the term “antenna” may refer to one or more antennas, one or more antenna panels, one or more antenna groups, one or more sets of antenna elements, or one or more antenna arrays. The term “antenna panel” may refer to a group of antennas (such as antenna elements) arranged in an array or panel, which may facilitate beamforming by manipulating parameters associated with the group of antennas. In some implementations, an antenna panel may support RF beamforming for a signal transmitted or received via an antenna port. The term “antenna module” may refer to circuitry including one or more antennas as well as one or more other components (such as filters, amplifiers, processors, beamformers) associated with integrating the antenna module into a device such as a network entity 105 or a UE 115.

Beamforming, such as directional transmission or directional reception, is a signal processing technique that may be used at a transmitting device or a receiving device (such as at a network entity 105, at a UE 115) to shape or steer a beam 175 (such as an antenna beam, a transmit beam, a receive beam) along a spatial path (such as along a direction), which may include one or more paths between a transmitting device and a receiving device. Beamforming may be achieved by combining signals communicated via multiple antenna elements of an antenna array such that signals propagating along some orientations (such as relative to the antenna array) experience constructive interference while others may experience destructive interference. Adjustments of signals communicated via the antenna elements may include a transmitting device or a receiving device applying phase offsets, amplitude offsets, or other adjustments to signals carried via (such as transmitted by, received by) antenna elements of the device, which may be defined by a beamforming weight set associated with a particular orientation (such as relative to the antenna array of the device).

Communication resources of the wireless communication system 100 (such as of a RAN 120) may refer to a resource in the frequency domain (such as a frequency resource, an RF resource), a resource in the time domain (such as a time resource), a resource in the spatial domain (such as a spatial resource, a spatial layer), or a combination thereof. The wireless communication system 100 may leverage orthogonality of such resources to convey different communications to or from different devices (such as for a communication link 125, for a communication link 135, for unicast communication, for multicast communication, for broadcast communication).

A frequency resource may refer to a frequency or range of frequencies (such as a bandwidth, a frequency channel) of a frequency band implemented for wireless communication. For example, a frequency resource may refer to a resource of a lower frequency band (such as Frequency Range 1 (FR1), between 425 MHz and 7.125 GHz), a mid-band (such as Frequency Range 3 (FR3), between 7.125 GHz and 24.25 GHz), or an upper frequency band (such as Frequency Range 2 (FR2), between 24.25 GHz and 71 GHz). Communication in the upper frequency band may be referred to as millimeter wave (mmW) communication, and communication above an upper frequency band (such as between mmW and THz frequencies, between 100 GHz and 1 THz) may be referred to as sub-Terahertz (sub-THz) communication.

A frequency resource may refer to a “carrier” (such as a frequency channel), or portion thereof, and a carrier bandwidth may be referred to as a “system bandwidth.” A carrier may be subdivided in the frequency domain, including into subcarriers, bandwidth parts (BWPs), or both. For example, a resource block (RB), such as a physical resource block (PRB), may be defined in accordance with a set of subcarriers (such as twelve consecutive subcarriers in the frequency domain), and a BWP may be configured in accordance with a set of RBs (such as a set of contiguous RBs).

A frequency resource may be configured to carry either downlink communication or uplink communication (such as in a frequency division duplexing (FDD) configuration), or may be configured to carry both downlink and uplink communication (such as in a time division duplexing (TDD) configuration, in a sub-band full duplex (SBFD) configuration). One or more numerologies for a carrier may be supported, each associated with a subcarrier spacing (SCS) and a cyclic prefix (CP). Supported numerologies may vary by frequency range (such as FR1, FR2, FR3), and a carrier may be divided into portions (such as BWPs) having the same or different numerologies. BWPs may be configured as uplink BWPs or downlink BWPs (such as by a network entity 105), including in response to network conditions (such as to allocate uplink and downlink BWPs in response to traffic conditions), device capability (such as allocating BWPs with a greater quantity of RBs to UEs 115 with relatively higher capabilities), or both. A UE 115 may be configured with a set of multiple BWPs (such as a set of uplink BWPs, a set of downlink BWPs, or both), and a single BWP of a set (such as an active UL BWP, an active DL BWP, or both) may be active at a given time, such that communication of a UE 115 is supported by active BWP(s).

A time resource may refer to a duration of a frame (such as a radio frame, a frame structure), or portion thereof. For example, a frame may span a duration of 10 ms, and each frame may be identified by a system frame number (SFN). A frame may be subdivided in the time domain, including into subframes, slots, mini-slots, or a combination thereof. Slots or mini-slots may each include a respective quantity of symbols (such as symbol durations, symbol periods, OFDM symbols), which may be a function of a configured CP. A duration of a symbol is a function of the SCS or frequency band of operation.

A spatial resource may refer to an antenna, an antenna direction, an antenna port, a signal direction (such as a beamforming direction), or other resource that supports spatial orthogonality. A device (such as a network entity 105, a UE 115) may perform communications of a given frequency resource and time resource with a single spatial resource (such as communication without regard to spatial orthogonality). Additionally, or alternatively, a device may implement multiple spatial resources to support multiple signal streams using resources that are overlapping in the time and frequency domains (such as to support MIMO techniques).

Signals of the wireless communication system 100 (such as of a RAN 120) may be communicated using one or more resource elements (REs), and an RE may refer to a resource that corresponds to one subcarrier in the frequency domain and one symbol in the time domain. An RE may be used to convey a modulation symbol corresponding to one or more bits of information (such as of a physical channel, of a reference signal) in accordance with a modulation scheme. For example, a quadrature phase shift keying (QPSK) or quadrature amplitude modulation (QAM) technique may be implemented to communicate one or more bits that are distinguished in accordance with phase components, amplitude components, or both of a signal conveyed using a RE. A quantity of bits carried by an RE may depend on an order of the modulation scheme, and a relatively higher order may correspond to a relatively higher rate of communication. A device may support communication of REs using multiple subcarriers concurrently by implementing multi-carrier modulation (MCM) techniques such as orthogonal frequency division multiplexing (OFDM) or discrete Fourier transform spread OFDM (DFT-S-OFDM), among others.

Physical channels may carry information using modulation symbols conveyed by corresponding REs. Physical shared channels (such as for communicating user data) may include a physical downlink shared channel (PDSCH) for communicating user data in a downlink direction and a physical uplink shared channel (PUSCH) for communicating user data in an uplink direction. Physical control channels (such as for managing communication via physical channels) may include a physical downlink control channel (PDCCH) for communicating downlink control information (DCI) and a physical uplink control channel (PUCCH) for communicating uplink control information (UCI). A network entity 105 may indicate (such as schedule, allocate) communication resources for a UE 115 using DCI, including indicating downlink resources of a PDSCH (such as in accordance with a downlink grant), uplink resources of a PUSCH (such as in accordance with an uplink grant), or a combination thereof. A control region (such as a control resource set (CORESET)) for a physical control channel may be configured in accordance with a pattern of REs in the time and frequency domains, and one or more control regions may be configured for a set of UEs. A UE 115 may monitor control regions for control information according to one or more search space sets, which may include a common search space set (such as for sending control information to one or more UEs 115), UE-specific search space sets (such as for sending control information to a UE 115), or a combination thereof. A physical broadcast channel (PBCH) may be used to broadcast parameters to UEs 115 to synchronize with a network entity 105 and establish communications (such as to establish a communication link 125).

Reference signals may be communicated to establish reference characteristics (such as a frequency reference, a temporal reference, a spatial reference, a signal quality reference) between devices of a RAN 120, which may support communication using physical channels. Reference signals communicated between network entities 105 and UEs 115 may include synchronization signals (such as a primary synchronization signal (PSS), a secondary synchronization signal (SSS)) that support temporal synchronization, channel state information-reference signals (CSI-RSs) that support evaluating downlink channel characteristics, sounding reference signals (SRSs) that support evaluating uplink channel characteristics, demodulation reference signals (DMRSs) that support demodulation, or phase tracking reference signals (PTRSs) for evaluating oscillator characteristics, among others. Network entities 105 and UEs 115 may receive and measure transmitted reference signals to support one or more of these and other functions.

Devices of the wireless communication system 100 may be configured to support one or more aspects for early-synchronization techniques for L3 handover procedures. For example, a UE 115 may include a processing system 140, and a network entity 105 may include a processing system 145, each of which may be configured to cause the respective device to perform (such as being configured as means for performing) one or more of the described operations. By configuring a processing system 140, a processing system 145, or a combination thereof in accordance with the described techniques, the communication system 100 (such as the RAN 120) may support early synchronization to reduce latency associated with a handover to the candidate cell.

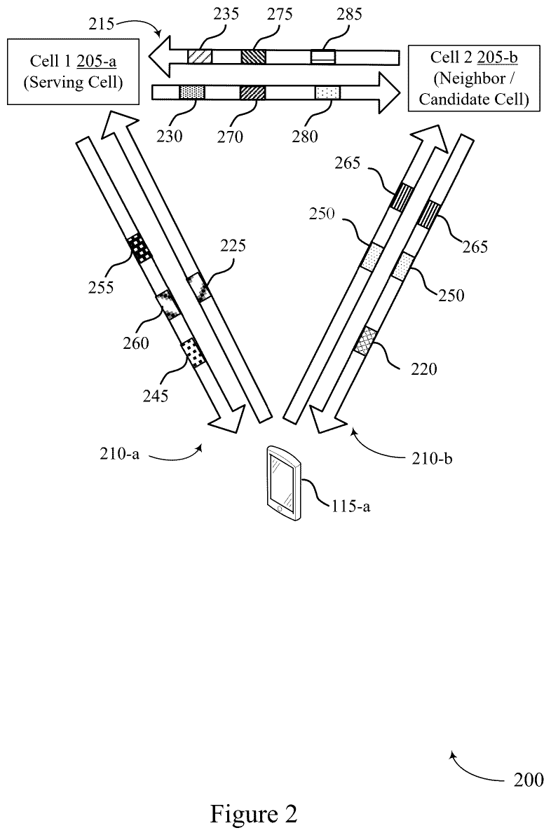

FIG. 2 shows an example of a signaling configuration 200 that supports early-synchronization techniques for L3 handover procedures. In some examples, aspects of the signaling configuration 200 may implement, or be implemented by, aspects of the wireless communications system 100. In particular, the signaling configuration 200 may support early-synchronization techniques for L3 handover procedures, as described herein.

The signaling configuration 200 may include a first cell 205-a, a second cell 205-b, and a UE 115-a. The cells may be examples of primary cells (PCells), secondary cells (SCells), and the like, that facilitate wireless communications between the network and the UE 115-a. The first cell 205-a and the second cell 205-b may be associated with (e.g., supported by) one or more network entities 105 (e.g., network nodes). For example, in some cases, the first cell 205-a may be associated with (e.g., supported by) a first network entity 105 (e.g., first network node, or “serving node”), and the second cell 205-b may be associated with (e.g., supported by) a second network entity 105 (e.g., second network node, or “candidate node”). In additional or alternative implementations, the first cell 205-a and the second cell 205-b may be associated with (e.g., supported by) the same network entity 105.

In some aspects, the cells and the UE 115-a may communicate with one another using a communication link 210-a, and a communication link 210-b, which may examples of 6th generation (6G), NR or LTE links, sidelink (e.g., PC5 links), and the like, between the respective devices. In some cases, the communication links may include examples of access links (e.g., Uu links) which may include bi-directional links that enable both uplink and downlink communication. For example, the UE 115-a may transmit uplink signals, such as uplink control signals, uplink data signals, or uplink reference signals, to the first cell 205-a (e.g., to one or more components of a network entity supporting the first cell 205-a) using the communication link 210-a, and the first cell 205-a (e.g., one or more components of the network entity 105 supporting the first cell 205-a) may transmit downlink signals, such as downlink control signals, downlink reference signals, or downlink data signals, to the UE 115-a using the communication link 210-a. In some examples, the first cell 205-a and the second cell 205-b may communicate with one another using a communication link 215 which may be an example of a 6th generation (6G), NR or LTE link, sidelink (e.g., PC5 link), backhaul link, fronthaul link, midhaul link, and the like, between the respective devices.

As the UE 115-a moves around within a network, the UE 115-a may be configured to switch from one cell to another. Some wireless networks may support LTM (e.g., L1/L2 triggered mobility and L3 trigger mobility), where the UE 115-a and cells exchange configuration and maintenance information for multiple candidate cells to allow for fast application of configurations for candidate cells (e.g., dynamic switching mechanisms among candidate serving cells, such as SPCells and SCells).

In the context of cell switching (e.g., LTM), the UE 115-a may be configured to perform cell switching/reselection procedures to switch between different cells as the UE 115-a moves throughout the network. When evaluating whether or not to perform a cell switching procedure from the first cell 205-a (e.g., serving cell) to the second cell 205-b (e.g., candidate cell), the UE 115-a may perform measurements (e.g., reference signal received power (RSRP), reference signal received quality (RSRQ) on reference signals 220 received from the second cell 205-b, and may transmit measurement reports 225 to the first cell 205-a to assist with cell switching decisions. Based on the measurement reports 225, the serving cell (e.g., first cell 205-a) may prepare an LTM candidate configuration for the second cell 205-b, and the serving cell (e.g., first cell 205-a) may transmit, to the UE 115-a, an RRC reconfiguration including the LTM candidate configuration for the second cell 205-b. In some examples, after LTM preparation, downlink early synchronization or uplink early synchronization towards the second cell 205-b (e.g., candidate cell) may be performed to reduce handover latency by skipping the synchronization procedures after a cell switch command is received. For example, the UE 115-a may communicate, with the second cell 205-b, one or more messages in accordance with early synchronization information. Downlink synchronization may be performed such that the TCI states of the LTM candidate cell (e.g., second cell 205-b) may be activated in advance before the candidate cell becomes the serving cell. Uplink synchronization may be performed such that the network initiates uplink timing advance (TA) acquisition (e.g., early TA value) procedure of the one or candidate cells that are different from the current serving cell. The early TA value acquisition procedure may be triggered by a PDCCH order or realized through UE-based TA measurement as configured by RRC. The serving cell (e.g., first cell 205-a) may change the UE serving cell by a cell switch command or handover command, such as via a MAC CE, which indicates an LTM candidate configuration that the serving cell previously prepared and provided to the UE 115-a through RRC signaling.

In addition to early-synchronization in the context of LTM, and in accordance with aspects of the present disclosure, early-synchronization techniques may also be applied for L3 handover procedures. For example, early uplink synchronization may be achieved by sending a preamble to the target cell (e.g., second cell 205-b) in advance. Additionally, inter-network-entity support of handover without a random access procedure (RACH-less handover) may be supported.

For the L3 handover procedures, the UE 115-a may perform measurements (e.g., RSRP, RSRQ) on reference signals 220 received from the second cell 205-b, and may transmit measurement reports 225 to the first cell 205-a to assist with cell switching decisions. Based on the measurement reports 225, the serving cell (e.g., first cell 205-a) may transmit, to the candidate cell (e.g., second cell 205-b), a handover request 230 with an early synchronization information request. The second cell 205-b, in response to the handover request 230, may transmit a handover request ACK message 235 that includes early synchronization information for the second cell 205-b. The serving cell (e.g., first cell 205-a) may transmit, to the UE 115-a, an RRC reconfiguration message 245 that includes the early synchronization information of the second cell 205-b. The UE 115-a may perform downlink or uplink early synchronization towards a target cell (e.g., second cell 205-b) by communicating one or more messages 250 in accordance with the early synchronization information before receiving the L3 handover command from serving cell (e.g., first cell 205-a). In some examples, the UE 115-a may perform downlink or uplink early synchronization towards conditional handover candidate cells, before conditional handover execution. The UE 115-a may obtain or derive TA value(s) for conditional handover candidate cells (or the target L3 handover cell), before handover execution.

For example, the UE 115-a may receive, from the first cell 205-a, a TA value 255 for communicating with the second cell 205-b. The UE 115-a may maintain TA validity timer(s) for conditional handover candidate cells or the target L3 handover cell. The UE 115-a may perform RACH-less L3 handover or RACH-less conditional handover execution, if the TA is valid towards a target or candidate cell. The source network entity or serving cell (e.g., first cell 205-a) may provide early uplink synchronization-related information to UE 115-a in advance (e.g., prior to sending the L3 handover command) or along with L3 handover command. The UE 115-a may receive, from the first cell 205-a, a L3 handover command 260, and the UE 115-a may switch to the second cell 205-b (e.g., perform a handover procedure from the first cell 205-a to the second cell 205-b). After the switch to the second cell 205-b, the UE 115-a may communicate messages 265 with the second cell 205-b in accordance with the TA value.

In some aspects, the serving cell (source network entity) may request the candidate cell (target network entity) to provide early uplink synchronization related information before L3 handover preparation or along with the L3 handover preparation. For example, the first cell 205-a may transmit, to the second cell 205-b, the handover request 230 with an early synchronization information request. The second cell 205-b, in response to the handover request 230, may transmit a handover request ACK message 235 that includes early synchronization information for the second cell 205-b. In some examples, the first cell 205-a may transmit, to the second cell 205-b, a request message 270 that requests a target cell configuration for communications with the second cell 205-b. The second cell 205-b may transmit, to the first cell 205-a, a message 275 indicating the target cell configuration for the second cell 205-b. In some examples, the first cell 205-a may transmit, to the second cell 205-b, a request message 280 requesting a TA value of the second cell 205-b. The second cell 205-b may transmit a message 285 including the TA value to the first cell 205-a. In some examples, the candidate DU may send TA value of the candidate handover candidate cells to the CU that provides the TA value to the source DU.

In some examples, in network triggered L3 handovers, a target cell configuration, such as a dedicated configuration including L1, L2, and/or L3 configurations, may be provided in a handover command. The dedicated configuration may include configured PUSCH resources for RACH-less access and RACH resources used by the UE 115-a during handover in case of TA is not valid (e.g., due to TA timer expiry). In conditional handover or LTM, the target cell configuration may be provided in the preparation phase. In the context of early-synchronization techniques for L3 handover procedures, the UE 115-a and the serving cell (e.g., first cell 205-a) may prepare early synchronization information and target configuration together or separately. In some aspects, the serving cell (e.g., source network entity) may obtain the early uplink synchronization configuration and the target or candidate cell(s) configuration from candidate network entity via a single procedure, and the uplink synchronization configuration and the target or candidate cell(s) configuration may be provided to the UE 115-a separately or together. In some aspects, the source network entity may obtain early uplink synchronization configuration and target or candidate cell(s) configuration from candidate network entity via separate procedures, and the and the uplink synchronization configuration and the target or candidate cell(s) configuration may be provided to the UE 115-a separately. In some aspects, the network may trigger the L3 handover with early synchronization. In some aspects, the UE 115-a may trigger the L3 handover (e.g., conditional handover) with early synchronization.

Early synchronization techniques for L3 handover may result in several different impacts, both on the Uu interface and the backhaul signaling. In the context of the Uu interface, aspects of the present disclosure may enable the UE 115-a to perform downlink/uplink early synchronization towards a certain (target) cell before receiving a L3 handover command from the serving cell. Further, in the context of conditional handover (CHO) (e.g., UE-initiated handovers) the UE 115-a may perform downlink/uplink early synchronization towards candidate CHO cells, before CHO execution. Moreover, in accordance with aspects of the present disclosure, the UE 115-a may “proactively” obtain/derive TA value(s) for CHO candidate cells (or the target L3 handover cell), before handover execution, where the UE 115-a may maintain TA validity timer(s) for CHO candidate cells (or the target L3 handover cell). In some aspects, the UE 115-a may perform RACH-less L3 handover or RACH-less CHO execution, if a TA is valid towards a target/candidate cell. The source network entity (e.g., serving cell) may provide early uplink synchronization-related information to UE “in advance” to sending L3 handover command or along with L3 handover command.

Aspects of the present disclosure may also result in backhaul signaling impacts. In particular, in the context of XnAp impacts, and in accordance with aspects of the present disclosure, the source network entity (e.g., serving cell) may request the target network entity (e.g., target/candidate cell) to provide early uplink synchronization-related information before L3 handover preparation, or along with L3 handover preparation. The candidate cell may send a TA value of the candidate cell to the serving cell. In the context of F1AP impacts, the candidate DU (e.g., DU of the candidate cell) may send a TA value of the CHO candidate cell to the CU, which may provide the TA value to the source DU (e.g., DU of the serving cell).

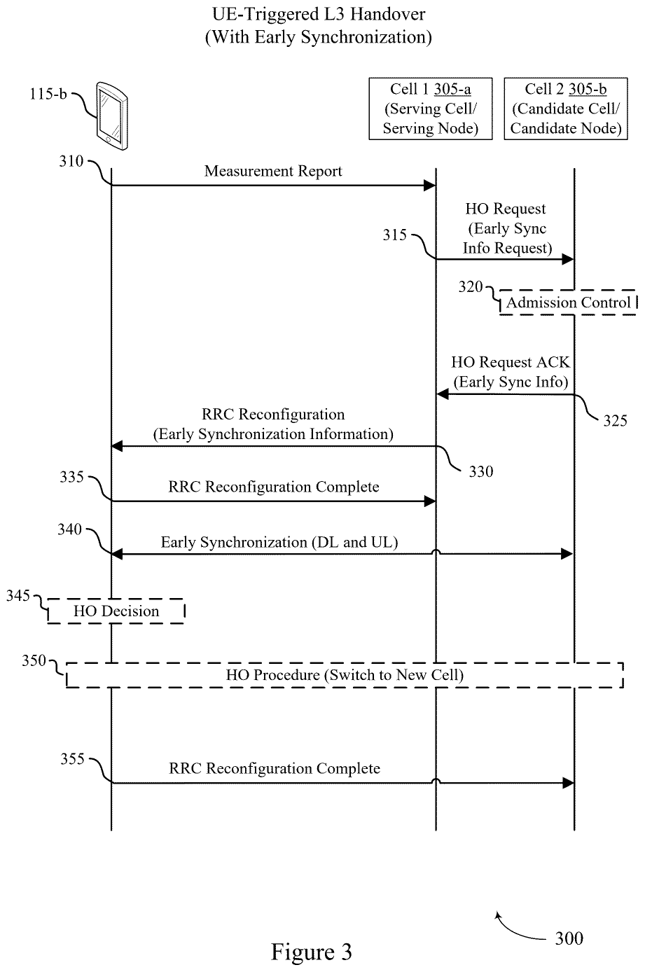

Various examples, approaches, and implementations for performing L3 handovers with early synchronization are shown and described in FIGS. 3-9.

FIG. 3 shows an example of a process flow 300 that supports early-synchronization techniques for L3 handover procedures. In some examples, aspects of the process flow 300 may implement, or be implemented by, aspects of the wireless communications system 100, the signaling configuration 200, or any combination thereof. In particular, the process flow 300 may illustrate signaling used for UE-triggered L3 handover (e.g., conditional handover) with early synchronization.

The process flow 300 includes a UE 115-b, a first cell 305-a, and a second cell 305-b, which may be examples of wireless devices as described herein. For example, the UE 115-b, the first cell 305-a, and the second cell 305-b illustrated in FIG. 3 may include examples of the UEs 115-a, the first cell 205-a, and the second cell 205-b, as illustrated in FIG. 2. In this regard, the first cell 305-a may be an example of a current serving cell, and the second cell 305-b may be an example of neighboring cell or candidate cell. As described previously herein, the first cell 305-a and the second cell 305-b may be associated with (e.g., supported by) the same or different network entities. For instance, in some cases, the first cell 305-a may be associated with or otherwise supported by a first network node (e.g., “serving node”), and the second cell 305-b may be associated with or otherwise supported by a second network node (e.g., “candidate node”). In this regard, any description in FIG. 3 associated with communications performed with or by the respective cells 305 may also be understood to refer to communications performed with or by corresponding network nodes (e.g., serving node, candidate node).

In some examples, the operations illustrated in process flow 300 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 310, the UE 115-c may transmit a measurement report (e.g., L3 measurement report) to the first cell 305-a. The measurement report may be associated with measurements performed on reference signals received from the second cell 305-b. The first cell 305-a may trigger preparation for conditional handover and early synchronization towards the second cell 305-b.

At signaling operation 315, the first cell 305-a may transmit, to the second cell 305-b, a handover request to second cell 305-b requesting conditional handover information and early synchronization information. That is, the serving cell may decide to trigger preparation for CHO and early synchronization towards the candidate cell(s) and send a handover request to the candidate cell requesting CHO information and early synchronization information.

At operation 320, the second cell 305-b may perform admission control, a process by which the target network entity evaluates whether it can handle the incoming UE 115-b and its associated traffic. This evaluation ensures that the target network entity has sufficient resources (e.g., bandwidth, processing power) to support the connection with the UE 115-b connection without impacting existing traffic.

At signaling operation 325, the second cell 305-b may transmit, to the first cell 305-a, a handover request ACK including information for conditional handover (e.g., execution condition) and early synchronization information. That is, the candidate cell (e.g., candidate/target-gNB) may perform admission control and send a handover request ACK including information required for CHO (e.g., execution condition) and early synchronization information to the serving cell (e.g., source-gNB).

As described previously herein, the early synchronization information may include, but is not limited to, a RACH configuration for communications with the candidate cell, an RRC configuration for the candidate cell, a TCI state for communications with the candidate cell, or any combination thereof.

At signaling operation 330, the first cell 305-a may transmit, to the UE 115-b, an RRC reconfiguration message (e.g., L3 message). The RRC reconfiguration message may include the CHO information and the early synchronization information of the second cell 305-b.

At signaling operation 335, the UE 115-b may transmit, to the first cell 305-a, an RRC reconfiguration complete message (e.g., in response to the RRC reconfiguration message at signaling operation 330).

At signaling operation 340, the UE 115-b may perform early synchronization towards the second cell 305-b. For the early synchronization, the UE 115-b and second cell 305-b may perform a random access procedure during which the UE 115-b and the candidate cell exchange random access messages with one another.

At operation 345, the UE 115-b may make a handover decision. That is, the UE 115-b may evaluate whether or not CHO execution conditions are satisfied to trigger a handover procedure to the second cell 305-b.

At operation 350, the UE 115-b may switch to the second cell 305-b after the CHO execution conditions are met. That is, the UE 115-b may perform a handover procedure from the serving cell to the candidate cell. During the handover procedure, the UE 115-b may exchange signaling (e.g., RACH messages/signaling) with the candidate cell. At signaling operation 355, the UE 115-b may transmit, to the second cell 305-b, an RRC reconfiguration complete message. In some examples, the operations 310 through 340 may be referred to as a preparation phase for the handover, and the operations 345 through 355 may be referred to as the execution phase of the handover (to execute the cell switch). The UE 115-a may perform the RA procedure or a configured grant transmission depending on availability of the TA value for the candidate cell.

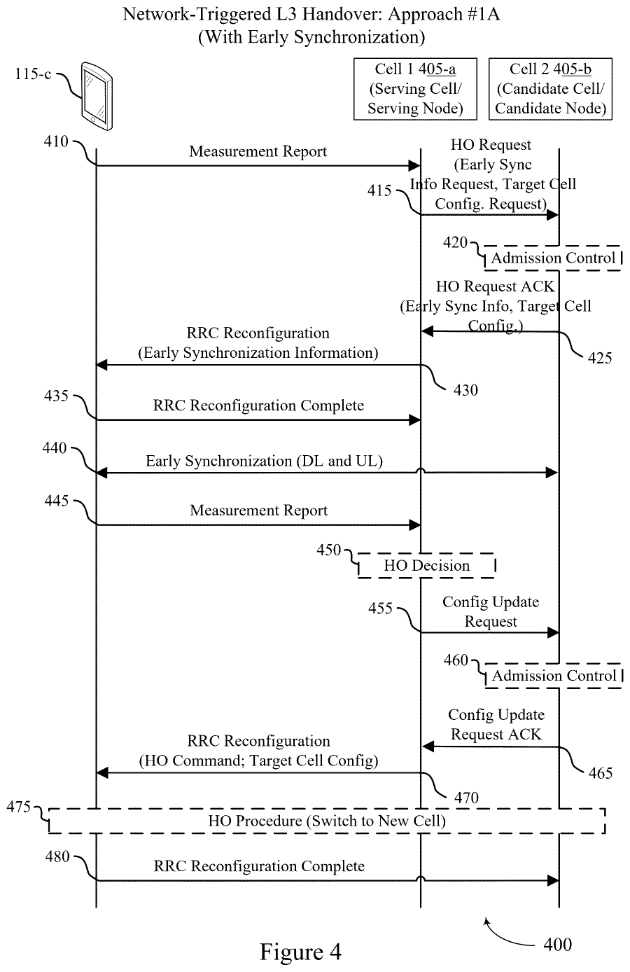

FIG. 4 shows an example of a process flow 400 that supports early-synchronization techniques for L3 handover procedures. In some examples, aspects of the process flow 400 may implement, or be implemented by, aspects of the wireless communications system 100, the signaling configuration 200, or any combination thereof. In particular, the process flow 400 may illustrate signaling used for network triggered L3 handover with early synchronization.

The process flow 400 includes a UE 115-c, a first cell 405-a, and a second cell 405-b, which may be examples of wireless devices as described herein. For example, the UE 115-c, the first cell 405-a, and the second cell 405-b illustrated in FIG. 4 may include examples of the UEs 115-a, the first cell 205-a, and the second cell 205-b, as illustrated in FIG. 2. In this regard, the first cell 405-a may be an example of a current serving cell, and the second cell 405-b may be an example of neighboring cell or candidate cell. As described previously herein, the first cell 405-a and the second cell 405-b may be associated with (e.g., supported by) the same or different network entities. For instance, in some cases, the first cell 405-a may be associated with or otherwise supported by a first network node (e.g., “serving node”), and the second cell 405-b may be associated with or otherwise supported by a second network node (e.g., “candidate node”). In this regard, any description in FIG. 4 associated with communications performed with or by the respective cells 405 may also be understood to refer to communications performed with or by corresponding network nodes (e.g., serving node, candidate node).

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 410, the UE 115-c may transmit a measurement report (e.g., L3 measurement report) to the first cell 405-a. In some aspects, the measurement report may include information associated with communications between the UE 115-c and the candidate cell 405-b (e.g., measurements performed by the UE 115-c on signals received from the candidate cell 405-b). The first cell 405-a may decide to trigger downlink or uplink early synchronization towards the second cell 405-b based on the measurement report.

At signaling operation 415, the first cell 405-a may transmit, to the second cell 405-b, a request that the second cell 405-b provide early synchronization information. In some examples, the request may be that the second cell 405-b provide early synchronization information and a target cell configuration information associated with the candidate cell 405-b.

As described previously herein, the early synchronization information may include, but is not limited to, a RACH configuration for communications with the candidate cell, an RRC configuration for the candidate cell, a TCI state for communications with the candidate cell, or any combination thereof. Comparatively, the target cell configuration information may include an L1, L2, and/or L3 configuration. Moreover, the target cell configuration may include a RACH configuration, a configured grant, or both, that indicates resources for RACH-based or RACH-less communications with the candidate cell. For example, the target cell configuration may include configured PUSCH resources for RACH-less access, and/or RACH resources used by the UE 115-c during handover in cases where the TA of the candidate cell 405-b is not valid (e.g., due to TA timer expiry).

At operation 420, the second cell 405-b may perform admission control, a process by which the target network entity evaluates whether it can handle the incoming UE 115-c and its associated traffic. This evaluation ensures that the target network entity has sufficient resources (e.g., bandwidth, processing power) to support the connection with the UE 115-c connection without impacting existing traffic.

At signaling operation 425, the second cell 405-b may transmit, to the first cell 405-a, a handover request ACK including information for early synchronization toward the second cell 405-b. In some examples, the handover request ACK may include early synchronization information and target configuration information associated with the candidate cell 405-b.

At signaling operation 430, the first cell 405-a may transmit, to the UE 115-c, an RRC reconfiguration message (e.g., first L3 message). The RRC reconfiguration message may include the early synchronization information of the second cell 405-b. In some examples, the first cell 405-a may store the target configuration information received from the second cell 405-b.

At signaling operation 435, the UE 115-c may transmit, to the first cell 405-a, an RRC reconfiguration complete message (e.g., in response to the RRC reconfiguration message at signaling operation 430).

At signaling operation 440, the UE 115-c may perform early synchronization towards the second cell 405-b. For the early synchronization, the UE 115-c and second cell 405-b may perform a random access procedure.

At signaling operation 445, the UE 115-c may transmit a measurement report (e.g., L3 measurement report) to the first cell 405-a. In particular, the L3 measurement report at signaling operation 445 may be generated based on the early synchronization communications performed at signaling operation 440.

At operation 450, the first cell 405-a may make a handover decision. For example, the first cell 405-a may determine to hand the UE 115-c over to the candidate cell 405-b based on the measurement report received at signaling operation 445.

At signaling operation 455, the first cell 405-a may transmit, to the second cell 405-b, a configuration update request that requests updated configuration information associated with the second cell 405-b.

At signaling operation 460, the second cell 405-b may perform admission control.

At signaling operation 465, the second cell 405-b may transmit, to the first cell 405-a, a handover request ACK including the latest determined target configuration information. That is, the second cell 405-b may respond with an updated (e.g., most recent) target cell configuration associated with the second cell 405-b.

At signaling operation 470, the first cell 405-a may transmit, to the UE 115-c, an RRC reconfiguration message (e.g., second L3 message). The RRC reconfiguration message may include the handover command and the latest target cell configuration information received from the second cell 405-b.

At operation 475, the UE 115-c may switch to the second cell 405-b. That is, the UE 115-a may perform a handover procedure from the first cell 405-a to the candidate cell 405-b. During the handover procedure, the UE 115-c may exchange signaling (e.g., RACH messages/signaling) with the candidate cell 405-b.

At signaling operation 480, the UE 115-c may transmit, to the second cell 405-b, an RRC reconfiguration complete message. In some examples, the operations 410 through 440 may be referred to as a preparation phase for the handover, and the operations 445 through 480 may be referred to as the execution phase of the handover. The UE 115-c may perform the RA procedure or a configured grant transmission depending on availability of the TA value.

In some network-triggered L3 handover procedures, the target cell configuration (e.g., dedicated configuration including L1/L2/L2 configurations) may be provided via the handover command (whereas, in the context of CHO/LTM, the target cell configuration may be provided in the preparation phase). Aspects of the present disclosure are directed to detailed procedures for the UE 115-c and network (e.g., serving cell 405-a, candidate cell 405-b) to prepare early synchronization information and the target cell configuration either via a single procedure (Approaches #1A, #1B) or via separate procedures (Approach #2).

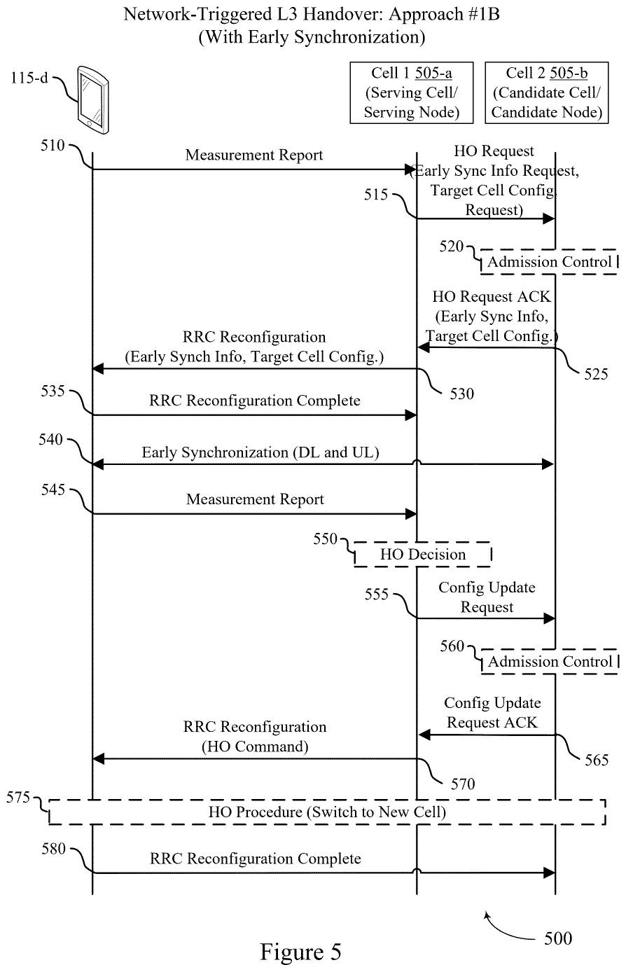

In particular, FIG. 4 illustrates an Approach #1A, where the serving cell 405-a (e.g., source gNB) obtains the early uplink synchronization information/configuration and the target cell configuration from the candidate gNB(s) via a single procedure, where the early synchronization information and the target cell configuration are provided to the UE 115-a separately. That is, in FIG. 4 (and in accordance with Approach #1A), the early synchronization information is provided to the UE 115-c via the signaling operation 430, whereas the target cell configuration is provided to the UE 115-c via the signaling operation 470. Comparatively, in Approach #1B (shown and described in FIG. 5), the early synchronization information and the target cell configuration may be provided to the UE 115 together (e.g., via the same message).

FIG. 5 shows an example of a process flow 500 that supports early-synchronization techniques for L3 handover procedures. In some examples, aspects of the process flow 500 may implement, or be implemented by, aspects of the wireless communications system 100, the signaling configuration 200, or any combination thereof. In particular, the process flow 500 may illustrate signaling used for network triggered L3 handover with early synchronization and with the target configuration being provided to the UE during the preparation phase.

The process flow 500 includes a UE 115-d, a first cell 505-a, and a second cell 505-b, which may be examples of wireless devices as described herein. For example, the UE 115-d, the first cell 505-a, and the second cell 505-b illustrated in FIG. 5 may include examples of the UEs 115-a, the first cell 205-a, and the second cell 205-b, as illustrated in FIG. 2. In this regard, the first cell 505-a may be an example of a current serving cell, and the second cell 505-b may be an example of neighboring cell or candidate cell. As described previously herein, the first cell 505-a and the second cell 505-b may be associated with (e.g., supported by) the same or different network entities. For instance, in some cases, the first cell 505-a may be associated with or otherwise supported by a first network node (e.g., “serving node”), and the second cell 505-b may be associated with or otherwise supported by a second network node (e.g., “candidate node”). In this regard, any description in FIG. 5 associated with communications performed with or by the respective cells 505 may also be understood to refer to communications performed with or by corresponding network nodes (e.g., serving node, candidate node).

In some examples, the operations illustrated in process flow 500 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 510, the UE 115-d may transmit a measurement report. In some aspects, the measurement report may include information associated with communications between the UE 115-c and the candidate cell 505-b (e.g., measurements performed by the UE 115-c on signals received from the candidate cell 505-b). The first cell 505-a may decide to trigger downlink or uplink early synchronization towards the second cell 505-b based on the measurement report.

At signaling operation 515, the first cell 505-a may transmit, to the second cell 505-b, a request that the second cell 505-b provide early synchronization information and target configuration information associated with the candidate cell 405-b. As described previously herein, the early synchronization information may include, but is not limited to, a RACH configuration for communications with the candidate cell, an RRC configuration for the candidate cell, a TCI state for communications with the candidate cell, or any combination thereof. Comparatively, the target cell configuration information may include an L1, L2, and/or L3 configuration. Moreover, the target cell configuration may include a RACH configuration, a configured grant, or both, that indicates resources for RACH-based or RACH-less communications with the candidate cell. For example, the target cell configuration may include configured PUSCH resources for RACH-less access, and/or RACH resources used by the UE 115-c during handover in cases where the TA of the candidate cell 505-b is not valid (e.g., due to TA timer expiry).

At operation 520, the second cell 505-b may perform admission control, as described previously herein.

At signaling operation 525, the second cell 505-b may transmit, to the first cell 505-a, a handover request ACK including early synchronization information and the target cell configuration associated with the second cell 505-b.

At signaling operation 530, the first cell 505-a may transmit, to the UE 115-d, an RRC reconfiguration message (e.g., first L3 message). The RRC reconfiguration message may include the early synchronization information and the target cell configuration of the second cell 505-b. That is, in accordance with Approach #1B shown and described in FIG. 5, the early synchronization information and the target cell configuration may be provided to the UE 115-d together (as compared to Approach #1A in FIG. 4, where the early synchronization information and the target cell configuration are provided separately).

At signaling operation 535, the UE 115-d may transmit, to the first cell 505-a, an RRC reconfiguration complete message.

At signaling operation 540, the UE 115-d may perform early synchronization towards the second cell 505-b. For the early synchronization, the UE 115-d and second cell 505-b may perform the RA procedure.

At signaling operation 545, the UE 115-d may transmit a measurement report to the first cell 505-a. In particular, the measurement report at signaling operation 545 may be generated based on the early synchronization communications performed at signaling operation 540.

At operation 550, the first cell 505-a may make a handover decision. For example, the first cell 405-a may determine to hand the UE 115-d over to the candidate cell 505-b based on the measurement report received at signaling operation 545.

At signaling operation 555, the first cell 505-a may transmit, to the second cell 505-b, a configuration update request that requests an updated target cell configuration associated with the second cell 505-b.

At operation 560, the second cell 505-b may perform admission control.

At signaling operation 565, the second cell 505-b may transmit, to the first cell 505-a, a handover request ACK including the latest determined target cell configuration information. That is, the second cell 505-b may respond with an updated (e.g., most recent) target cell configuration associated with the candidate cell 505-b.

At signaling operation 570, the first cell 505-a may transmit, to the UE 115-d, an RRC reconfiguration message (e.g., second L3 message). The RRC reconfiguration message may include the L3 cell switch command. In some examples, the RRC reconfiguration message may include the latest determined target cell configuration information.

At operation 575, the UE 115-d may switch to the second cell 505-b. That is, the UE 115-a may perform a handover procedure from the serving cell 405-a to the candidate cell 405-b. During the handover procedure, the UE 115-c may exchange signaling (e.g., RACH messages/signaling) with the candidate cell 405-b.

At signaling operation 580, the UE 115-d may transmit, to the second cell 505-b, an RRC reconfiguration complete message. In some examples, the operations 510 through 540 may be referred to as a preparation phase for the handover, and the operations 545 through 580 may be referred to as the execution phase of the handover.

The process flow 400 and the process flow 500 include several common steps. For example, signaling operation 415 and signaling operation 515 may be common with the first cell transmitting, to the second cell 405-b, the handover request. In some examples, the handover request with the request for target configuration information may be either explicit (e.g., an indication of the request for target configuration information within the handover request) or implicit (e.g., a message identifier may imply a request for the target configuration information). Signaling operation 425 and signaling operation 525 may be common with the second cell 405-b transmitting, to the first cell 405-a, a handover request ACK including information for early synchronization and target configuration information. In some examples, the second cell or target network entity may request the first cell or source network entity to ask for the latest configuration when handover is executed. In some examples, the second cell may indicate a validity timer associated with the configuration. In some examples, the message of signaling operation 570 may not be the RRC reconfiguration message but may be a newly defined cell switch configuration message. In some cases, for signaling operation 570, the UE may identify the L3 cell switch command explicitly (e.g., by message identifier or transaction ID) or implicitly (e.g., if the RRC message includes information such as a target configuration ID or if the configuration information is empty).

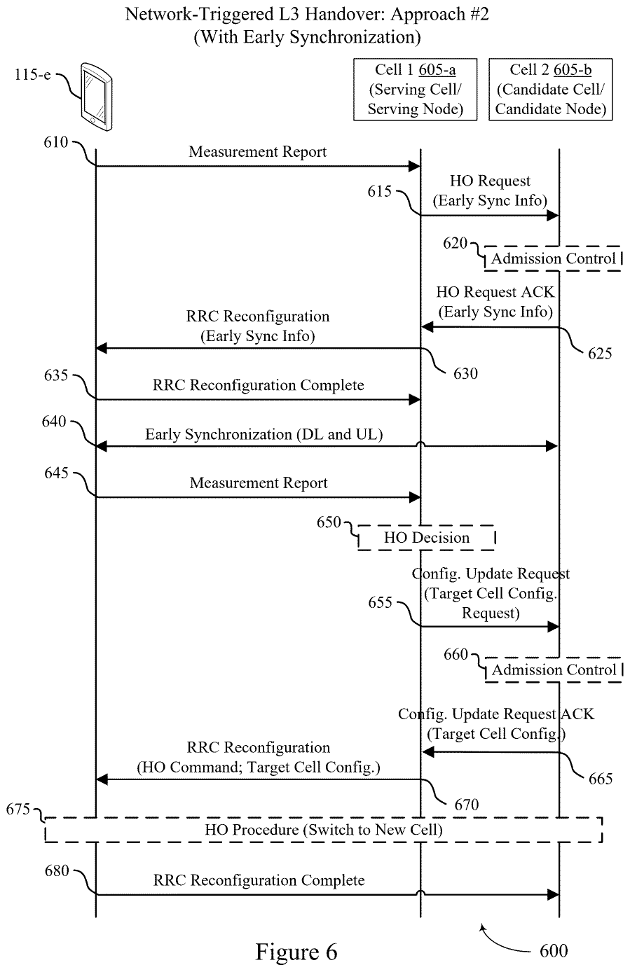

FIG. 6 shows an example of a process flow 600 that supports early-synchronization techniques for L3 handover procedures. In some examples, aspects of the process flow 600 may implement, or be implemented by, aspects of the wireless communications system 100, the signaling configuration 200, or any combination thereof. In particular, the process flow 600 may illustrate signaling used for network triggered L3 handover with early synchronization information being provided separately from the target configuration information to the UE.

The process flow 600 includes a UE 115-e, a first cell 605-a, and a second cell 605-b, which may be examples of wireless devices as described herein. For example, the UE 115-e, the first cell 605-a, and the second cell 605-b illustrated in FIG. 6 may include examples of the UEs 115-a, the first cell 605-a, and the second cell 205-b, as illustrated in FIG. 2. In this regard, the first cell 605-a may be an example of a current serving cell, and the second cell 605-b may be an example of neighboring cell or candidate cell. As described previously herein, the first cell 605-a and the second cell 605-b may be associated with (e.g., supported by) the same or different network entities. For instance, in some cases, the first cell 605-a may be associated with or otherwise supported by a first network node (e.g., “serving node”), and the second cell 605-b may be associated with or otherwise supported by a second network node (e.g., “candidate node”). In this regard, any description in FIG. 6 associated with communications performed with or by the respective cells 605 may also be understood to refer to communications performed with or by corresponding network nodes (e.g., serving node, candidate node).

In some examples, the operations illustrated in process flow 600 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 610, the UE 115-e may transmit a measurement report to the first cell 405-a. In some aspects, the measurement report may include information associated with communications between the UE 115-c and the candidate cell 605-b (e.g., measurements performed by the UE 115-e on signals received from the candidate cell 605-b). The first cell 605-a may decide to trigger downlink or uplink early synchronization towards the second cell 605-b based on the measurement report.

At signaling operation 615, the first cell 605-a may transmit, to the second cell 605-b, a request that the second cell 605-b provide early synchronization information associated with the candidate cell 605-b. As described previously herein, the early synchronization information may include, but is not limited to, a RACH configuration for communications with the candidate cell, an RRC configuration for the candidate cell, a TCI state for communications with the candidate cell, or any combination thereof.

At operation 620, the second cell 605-b may perform admission control, as described previously herein.

At signaling operation 625, the second cell 605-b may transmit, to the first cell 605-a, a handover request ACK including the early synchronization information associated with the second cell 605-b.

At signaling operation 630, the first cell 605-a may transmit, to the UE 115-e, an RRC reconfiguration message (e.g., first L3 message). The RRC reconfiguration message may include the early synchronization information of the second cell 605-b.

At signaling operation 635, the UE 115-e may transmit, to the first cell 605-a, an RRC reconfiguration complete message.

At signaling operation 640, the UE 115-e may perform early synchronization towards the second cell 605-b. For the early synchronization, the UE 115-e and second cell 605-b may perform a random access procedure.

At signaling operation 645, the UE 115-e may transmit a measurement report to the first cell 605-a. In particular, the measurement report at signaling operation 645 may be generated based on the early synchronization communications performed at signaling operation 640.

At operation 650, the first cell 605-a may make a handover decision. For example, the first cell 605-a may determine to hand the UE 115-e over to the candidate cell 605-b based on the measurement report received at signaling operation 645.

At signaling operation 655, the first cell 605-a may transmit, to the second cell 605-b, a configuration update request that requests a target cell configuration information for the second cell 605-b. As noted previously herein, the target cell configuration information may include an L1, L2, and/or L3 configuration. Moreover, the target cell configuration may include a RACH configuration, a configured grant, or both, that indicates resources for RACH-based or RACH-less communications with the candidate cell. For example, the target cell configuration may include configured PUSCH resources for RACH-less access, and/or RACH resources used by the UE 115-e during handover in cases where the TA of the candidate cell 405-b is not valid (e.g., due to TA timer expiry).

In this regard, as compared to Approaches #1A and #1B in FIGS. 4-5 where the first cell requests the early synchronization information and the target cell configuration via a single request/procedure (e.g., via signaling operations 415 and 515), in the context of Approach #2 in FIG. 6, the first cell 605-a may request the early synchronization information and the target cell configuration separately (e.g., via separate procedures at signaling operations 615 and 655).

At signaling operation 660, the second cell 605-b may perform admission control.

At signaling operation 665, the second cell 605-b may transmit, to the first cell 605-a, a configuration update request ACK including the target cell configuration information.

At signaling operation 670, the first cell 605-a may transmit, to the UE 115-e, an RRC reconfiguration message (e.g., second L3 message). The RRC reconfiguration message may include the handover command and the target cell configuration information.

At signaling operation 675, the UE 115-e may switch to the second cell 605-b. That is, the UE 115-e may perform a handover procedure from the serving cell 605-a to the candidate cell 605-b. During the handover procedure, the UE 115-e may exchange signaling (e.g., RACH messages/signaling) with the candidate cell 605-b.

At signaling operation 680, the UE 115-e may transmit, to the second cell 605-b, an RRC reconfiguration complete message. In some examples, the operations 610 through 640 may be referred to as a preparation phase for the handover, and the operations 645 through 680 may be referred to as the execution phase of the handover.

For all of the process flows 300-600 illustrated in FIG. 3-6, the UE 115 may be configured to determine a TA value for the candidate cell, where communications between the UE and the candidate cell are performed in accordance with the determined TA value. For L3 handover, the UE may obtain the TA value for the L3 handover candidate cell by receiving the TA value from the candidate cell, by autonomous derivation of the TA value, and/or by receiving the TA value from the serving cell. In some examples, the UE may receive the TA value from candidate cell via the random access response message or a MAC-CE after sending a physical random access channel transmission to candidate cell of the random access procedure.

In some examples, the UE may derive the TA value for a candidate cell (e.g., candidate cell #X) based on the downlink timing of the serving cell, the uplink timing of the serving cell and the downlink timing of the candidate cell (e.g., candidate cell #X). For example, the UE may know the serving cell TA value, may determine the downlink receiving time difference between the serving cell and the candidate cell, and may determine the TA value for the candidate cell as the TA value of the serving cell minus two times the downlink receiving time difference between the serving cell and the candidate cell. In another example, the UE may derive the TA value for a candidate cell (e.g., candidate cell #X) based on the downlink timing of another candidate cell (e.g., different candidate cell #Y where a valid TA is maintained in the UE), the uplink timing of the different candidate cell #Y and the downlink timing of the candidate cell #X. In some examples, the UE may be configured with an indication of how to obtain or calculate the TA values. For example, the indication may indicate for the UE to derive the TA value for the candidate cell using the serving cell, using the other different candidate cell or both the serving cell and the other candidate cell. In some cases, the configuration may indicate an allowed list of serving cells or candidate cells to use when deriving the TA value, or the configuration may indicate a denied list of serving cells or candidate cells not to use when deriving the TA value. In some examples, the configuration may be per frequency band of the candidate cell or per candidate cell.

In some examples, the UE may receive the TA value for the candidate cell from the serving cell. For the procedure where the source cell or source network entity obtains the early uplink synchronization configuration and the target cell configuration from candidate network entities via a single procedure as shown in FIG. 4 and FIG. 5, the candidate cell may send the TA value to the source cell based on a request from the source cell or without an explicit request for the TA value. For example, the candidate cell (or candidate DU) may transmit the TA value (or updated TA value) to the source cell (or source CU) without explicit request. In another example, the source cell (or source CU) may transmit, to the candidate cell (or candidate DU) a request for the TA value. After acquiring the TA value, the source cell may include the TA value in a message transmitted to the UE. In some examples, the UE may receive the TA value in MAC signaling or RRC signaling.

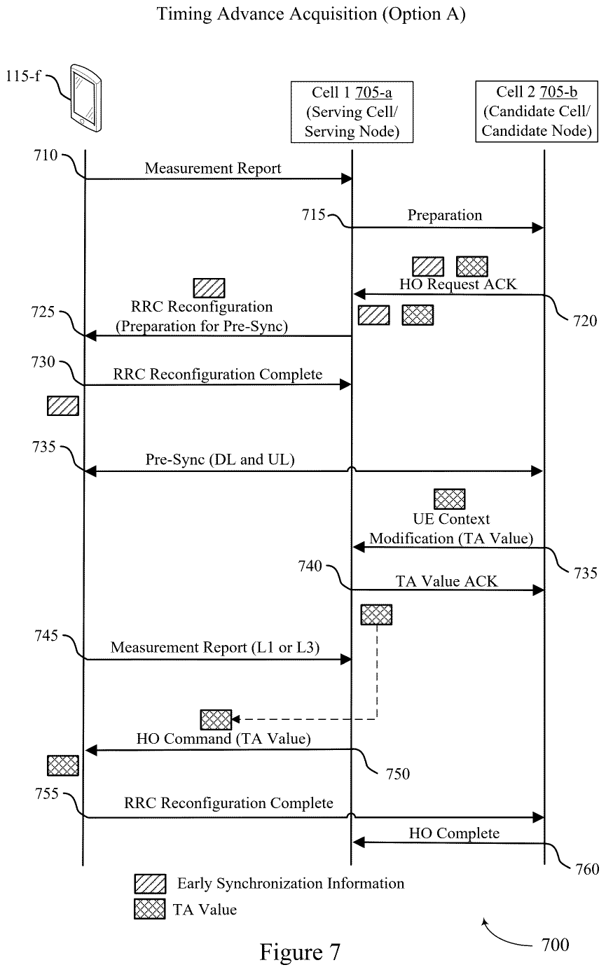

Various techniques for determining the TA value for a candidate cell in the context of L3 handovers are further shown and descried with reference to FIGS. 7-9.

FIG. 7 shows an example of a process flow 700 that supports early-synchronization techniques for L3 handover procedures. In some examples, aspects of the process flow 700 may implement, or be implemented by, aspects of the wireless communications system 100, the signaling configuration 200, or any combination thereof. In particular, the process flow 700 may illustrate signaling used for network triggered L3 handover with the TA value being provided without an explicit request.

The process flow 700 includes a UE 115-f, a first cell 705-a, and a second cell 705-b, which may be examples of wireless devices as described herein. For example, the UE 115-f, the first cell 705-a, and the second cell 705-b illustrated in FIG. 7 may include examples of the UEs 115-a, the first cell 205-a, and the second cell 205-b, as illustrated in FIG. 2. In this regard, the first cell 705-a may be an example of a current serving cell, and the second cell 705-b may be an example of neighboring cell or candidate cell. As described previously herein, the first cell 705-a and the second cell 705-b may be associated with (e.g., supported by) the same or different network entities. For instance, in some cases, the first cell 705-a may be associated with or otherwise supported by a first network node (e.g., “serving node”), and the second cell 705-b may be associated with or otherwise supported by a second network node (e.g., “candidate node”). In this regard, any description in FIG. 7 associated with communications performed with or by the respective cells 705 may also be understood to refer to communications performed with or by corresponding network nodes (e.g., serving node, candidate node).

In some examples, the operations illustrated in process flow 700 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 710, the UE 115-f may transmit a measurement report to the first cell 705-a. The first cell 705-a may decide to trigger downlink or uplink early synchronization towards the second cell 705-b.

At signaling operation 715, the first cell 705-a may transmit, to the second cell 705-b, a handover request that the second cell 705-b provide early synchronization information and target configuration information. During the preparation phase, the second cell 705-b may determine a dummy or default TA value (e.g., value of zero). In some examples, the second cell 705-b may determine an estimated or initial TA value.

At signaling operation 720, the second cell 705-b may transmit, to the first cell 705-a, a handover request ACK including information for early synchronization toward the second cell 705-b and target configuration information. In some examples, the handover request ACK may include the dummy, default, estimated or initial TA value.

At signaling operation 725, the first cell 705-a may transmit, to the UE 115-f, the RRC reconfiguration message. In some examples, the RRC reconfiguration message may include the early synchronization information.

At signaling operation 730, the UE 115-f may transmit an RRC reconfiguration complete message to the first cell 705-a (e.g., in response to the RRC reconfiguration message at signaling operation 725).

At signaling operation 735, the UE 115-f may perform early synchronization towards the second cell 705-b. For the early synchronization, the UE 115-f and second cell 705-b may perform a random access procedure.

At signaling operation 735, the second cell 705-b may trigger a procedure to update the reconfiguration message to be sent to the UE 115-f. For example, the second cell 705-b may transmit a UE context modification message to the first cell 705-a, where the UE context modification message includes an updated TA value. In other words, the second cell 705-b may autonomously provide the UE context medication message (and updated TA value) without an explicit request from the first cell 705-a.

At signaling operation 740, the first cell 705-a may transmit a message to the second cell 705-b in response to the UE context modification at signaling operation 735 (e.g., an acknowledgment of the updated TA value).

At signaling operation 745, the UE 115-f may transmit a measurement report to the first cell 705-a.

At signaling operation 750, the first cell 705-a may transmit, to the UE 115-f, a handover command that includes the updated TA value.

At signaling operation 755, the UE 115-f may transmit, to the second cell 705-b, an RRC reconfiguration complete message.

At signaling operation 760, the second cell 705-b may transmit a message to the first cell 705-a to indicate successful handover of the UE 115-f from the first cell 705-a to the second cell 705-b.

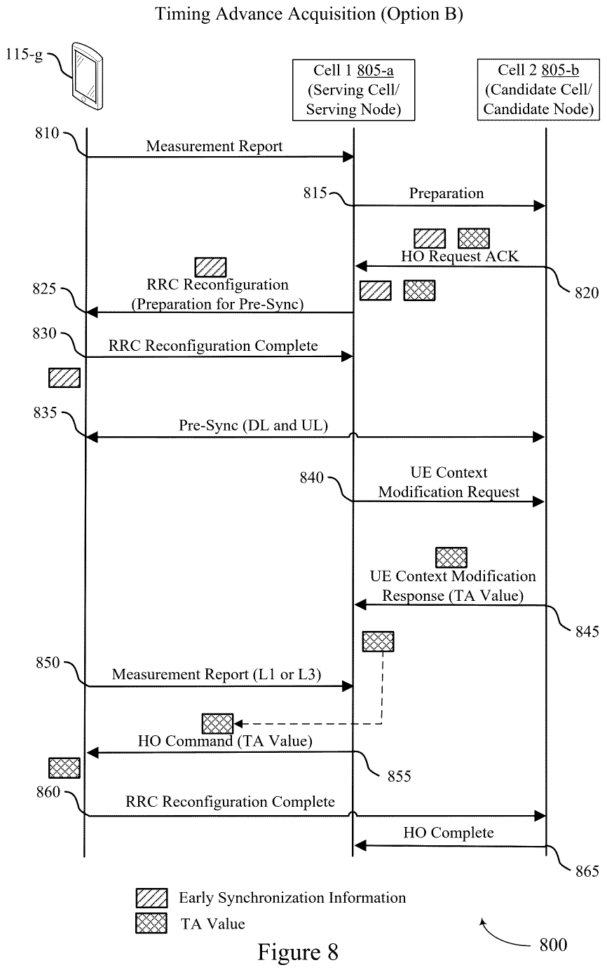

FIG. 8 shows an example of a process flow 800 that supports early-synchronization techniques for L3 handover procedures. In some examples, aspects of the process flow 800 may implement, or be implemented by, aspects of the wireless communications system 100, the signaling configuration 200, or any combination thereof. In particular, the process flow 800 may illustrate signaling used for network triggered L3 handover with the TA value being provided based on an explicit request.

For example, the UE 115-g, the first cell 805-a, and the second cell 805-b illustrated in FIG. 8 may include examples of the UEs 115-a, the first cell 205-a, and the second cell 205-b, as illustrated in FIG. 2. In this regard, the first cell 805-a may be an example of a current serving cell, and the second cell 805-b may be an example of neighboring cell or candidate cell. As described previously herein, the first cell 805-a and the second cell 805-b may be associated with (e.g., supported by) the same or different network entities. For instance, in some cases, the first cell 805-a may be associated with or otherwise supported by a first network node (e.g., “serving node”), and the second cell 805-b may be associated with or otherwise supported by a second network node (e.g., “candidate node”). In this regard, any description in FIG. 8 associated with communications performed with or by the respective cells 805 may also be understood to refer to communications performed with or by corresponding network nodes (e.g., serving node, candidate node).

In some examples, the operations illustrated in process flow 800 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 810, the UE 115-g may transmit a measurement report to the first cell 805-a. The first cell 805-a may decide to trigger downlink or uplink early synchronization towards the second cell 805-b.

At signaling operation 815, the first cell 805-a may transmit, to the second cell 805-b, a handover request that the second cell 805-b provide early synchronization information and target configuration information. During the preparation phase, the second cell 805-b may determine a dummy or default TA value (e.g., value of zero). In some examples, the second cell 805-b may determine an estimated or initial TA value.

At signaling operation 820, the second cell 805-b may transmit, to the first cell 805-a, a handover request ACK including information for early synchronization toward the second cell 805-b and target configuration information. In some examples, the handover request ACK may include the dummy, default, estimated or initial TA value.

At signaling operation 825, the first cell 805-a may transmit, to the UE 115-g, the RRC reconfiguration message, and the UE 115-g may transmit, to the first cell 805-a, the RRC reconfiguration complete message. In some examples, the RRC reconfiguration message may include the early synchronization information.

At signaling operation 830, the UE 115-g may transmit an RRC reconfiguration complete message to the first cell 805-a (e.g., in response to the RRC reconfiguration message at signaling operation 825).

At signaling operation 835, the UE 115-g may perform early synchronization towards the second cell 805-b. For the early synchronization, the UE 115-g and second cell 805-b may perform the RA procedure.

At signaling operation 840, the first cell 805-a may request the TA value from the second cell 805-b. That is, as compared to FIG. 7 where the second cell 705-b autonomously provides the updated TA value at signaling operation 735, the first cell 805-a in FIG. 8 may explicitly request an updated TA value at signaling operation 840. For example, the first cell 805-a may transmit, to the second cell 805-b, a UE context modification request message. The first cell 805-a may trigger this procedure after sending the early uplink synchronization procedure. For example, the first cell 805-a (or source CU or source network entity may trigger the request for the TA value when a pre-determined time has elapsed after early synchronization procedure (e.g., a pre-determined time after sending the PDCCH order to trigger RACH to the second cell 805-b)). The pre-determined time may be determined based on information from operations, administration, and maintenance (OAM), the second cell 805-b (e.g., the candidate DU), or any other information node. In response to the request for the TA value, the second cell 805-b (e.g., candidate DU or candidate network entity) may trigger a procedure to update reconfiguration message to be sent to the UE 115-g.

At signaling operation 845, the first cell 805-a may receive, from the second cell 805-b, the TA value. For example, the first cell 805-a may receive, from the second cell 805-b, the UE context modification response message including the TA value.

At signaling operation 850, the UE 115-g may transmit a measurement report to the first cell 705-a.

At signaling operation 855, the first cell 805-a may transmit, to the UE 115-g, a handover command including the TA value.

At signaling operation 860, the UE 115-g may transmit, to the second cell 805-b, an RRC reconfiguration complete message.

At signaling operation 865, the second cell 805-b may transmit a message to the first cell 805-a to indicate successful handover of the UE 115-g from the first cell 805-a to the second cell 805-b.

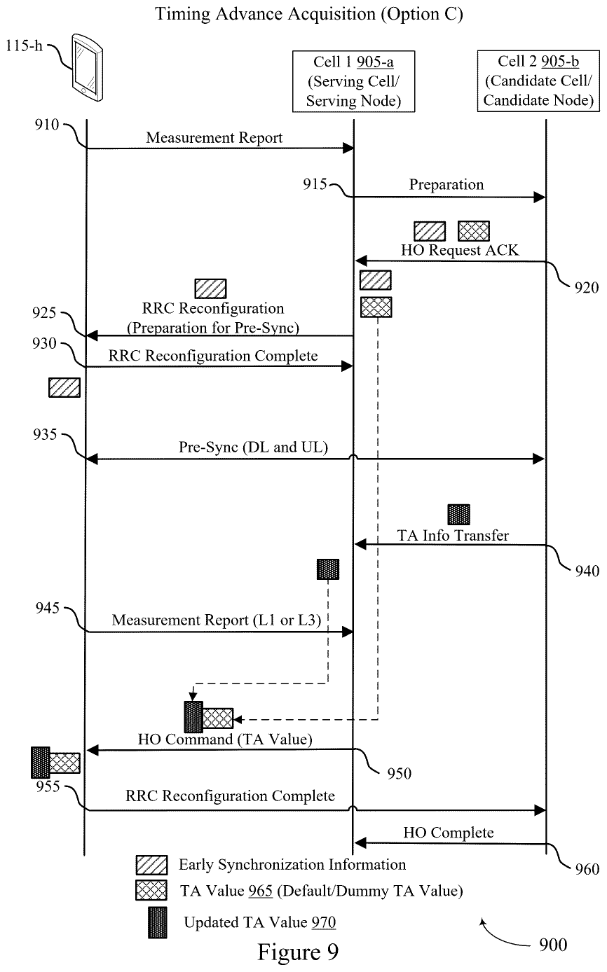

FIG. 9 shows an example of a process flow 900 that supports early-synchronization techniques for L3 handover procedures. In some examples, aspects of the process flow 900 may implement, or be implemented by, aspects of the wireless communications system 100, the signaling configuration 200, or any combination thereof. In particular, the process flow 900 may illustrate signaling used for network triggered L3 handover with the TA value being provided in messages transmitted by the serving cell or source network entity.

For example, the UE 115-h, the first cell 905-a, and the second cell 905-b illustrated in FIG. 9 may include examples of the UEs 115-a, the first cell 205-a, and the second cell 205-b, as illustrated in FIG. 2. In this regard, the first cell 905-a may be an example of a current serving cell, and the second cell 905-b may be an example of neighboring cell or candidate cell. As described previously herein, the first cell 905-a and the second cell 905-b may be associated with (e.g., supported by) the same or different network entities. For instance, in some cases, the first cell 905-a may be associated with or otherwise supported by a first network node (e.g., “serving node”), and the second cell 905-b may be associated with or otherwise supported by a second network node (e.g., “candidate node”). In this regard, any description in FIG. 9 associated with communications performed with or by the respective cells 905 may also be understood to refer to communications performed with or by corresponding network nodes (e.g., serving node, candidate node).

In some examples, the operations illustrated in process flow 900 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At signaling operation 910, the UE 115-h may transmit a measurement report to the first cell 905-a. The first cell 905-a may decide to trigger downlink or uplink early synchronization towards the second cell 905-b.

At signaling operation 915, the first cell 905-a may transmit, to the second cell 905-b, a handover request that the second cell 905-b provide early synchronization information and target configuration information. During the preparation phase, the second cell 905-b may determine a dummy or default TA value (e.g., value of zero). In some examples, the second cell 905-b may determine an estimated or initial TA value.

At signaling operation 920, the second cell 905-b may transmit, to the first cell 905-a, a handover request ACK including information for early synchronization toward the second cell 905-b and target configuration information. In some examples, the handover request ACK may include the dummy, default, estimated or initial TA value.

At signaling operation 925, the first cell 905-a may transmit, to the UE 115-h, the RRC reconfiguration message. In some examples, the RRC reconfiguration message may include the early synchronization information.

At signaling operation 930, the UE 115-h may transmit an RRC reconfiguration complete message to the first cell 905-a (e.g., in response to the RRC reconfiguration message at signaling operation 925).

At signaling operation 935, the UE 115-h may perform early synchronization towards the second cell 905-b. For the early synchronization, the UE 115-h and second cell 905-b may perform the random access (RA) procedure.

At signaling operation 940, the first cell 905-a may receive, from the second cell 905-b, the TA value. For example, the first cell 905-a may receive, from the second cell 905-b, the TA value via a TA information transfer procedure.

At signaling operation 945, the UE 115-h may transmit a measurement report to the first cell 905-a.

At signaling operation 950, the first cell 905-a may transmit, to the UE 115-g, a handover command. In some examples, the handover command may include the dummy, default, estimated, or initial TA value (e.g., TA value 965) transfer from signaling operation 920. In some examples, the handover command may also include the updated TA value (e.g., TA value 970) from the TA information transfer procedure of signaling operation 940. In some examples, the updated TA value 970 may be included in the RRC message transmitted to the UE 115-h. For example, the updated TA value 970 may be included inside the reconfiguration message or outside the reconfiguration message. In some examples, the first cell 905-a may transmit a MAC CE including the updated TA value 970, and the MAC CE may be multiplexed with the RRC message (e.g., handover command including the TA value 965). In some cases, the updated TA value 970 may be included in a TA command (TAC) transmitted from the first cell 905-a to the UE 115-h.

In some examples, when the UE 115-h receives the MAC CE, the UE 115-h may ignore TA value 965 (e.g., ignore the default/dummy TA value 965) included in RRC message (e.g., HO command) and use the updated TA value 970. For example, the RRC message may include the dummy, default, estimated, or initial TA value 965, and the MAC CE may include the updated TA value 970 from the TA information transfer. In this regard, the updated TA value 970 may be the actual, final TA value that will be used to communicate with the second cell 905-b. In additional or alternative implementations, the UE 115-h may derive a final TA value using both the default/dummy TA value 965 and the updated TA value 970. In this regard, the actual, final TA value used to communicate with the second cell 905-b may be determined based on a combination of both the default/dummy TA value 965 and the updated TA value 970 (e.g., the updated TA value 970 may be used to adjust the default/dummy TA value 965 to the actual, final TA value for the second cell 905-b). In some cases, the updated TA value 970 may be provided to the UE 115-h via a new MAC CE or via an existing MAC CE with the UE 115-h ignoring irrelevant fields of the existing MAC CE.

At signaling operation 955, the UE 115-h may transmit, to the second cell 905-b, an RRC reconfiguration complete message.

At signaling operation 960, the second cell 905-b may transmit a message to the first cell 905-a to indicate successful handover of the UE 115-h from the first cell 905-a to the second cell 905-b.

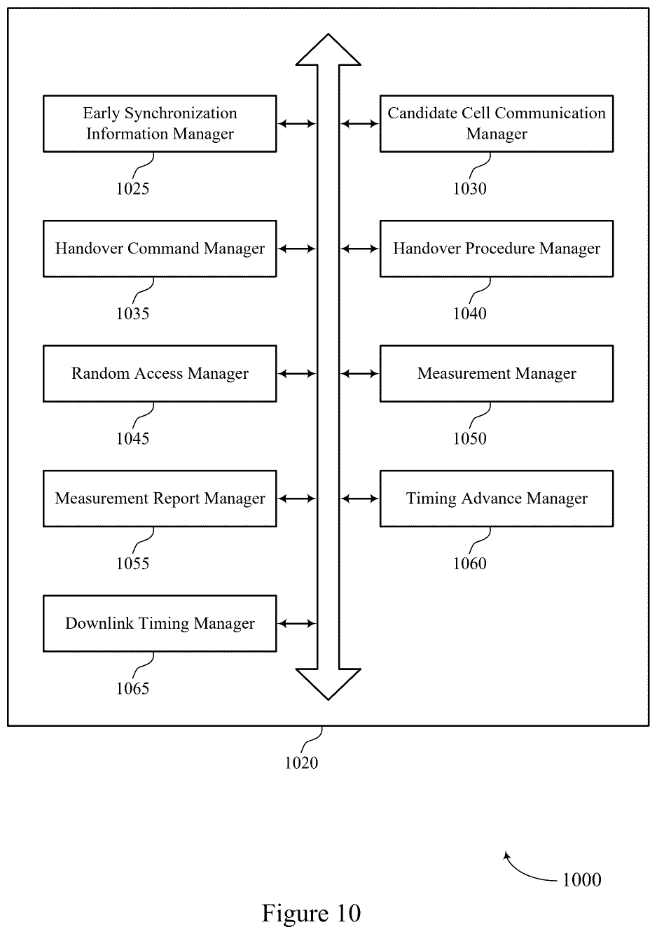

FIG. 10 shows an example 1000 of a processing system 1020 that supports early-synchronization techniques for L3 handover procedures. A processing system 1020 may be an example of a processing system 140 (such as of a UE 115) and may include an early synchronization information manager 1025, a candidate cell communication manager 1030, a handover command manager 1035, a handover procedure manager 1040, a random access manager 1045, a measurement manager 1050, a measurement report manager 1055, a TA manager 1060, a downlink timing manager 1065, or any combination thereof. A processing system 1020, or various component thereof, may be an example of means for performing (such as a means for causing a UE 115 to perform) various techniques described herein.

The early synchronization information manager 1025 may be configured to cause the UE 115 to receive, from a serving cell, a first L3 message including early synchronization information for a candidate cell, the early synchronization information including a random access configuration for communications with the candidate cell, a RRC configuration for the candidate cell, a TCI state for communications with the candidate cell, or any combination thereof. The candidate cell communication manager 1030 may be configured to cause the UE 115 to communicate with the candidate cell in accordance with the early synchronization information. The handover command manager 1035 may be configured to cause the UE 115 to receive, based on communicating with the candidate cell in accordance with the early synchronization information, a second L3 message including a handover command for the UE to perform a handover procedure from the serving cell to the candidate cell, the second L3 message further including a target cell configuration for communicating with the candidate cell. The handover procedure manager 1040 may be configured to cause the UE 115 to perform the handover procedure from the serving cell to the candidate cell in response to the second L3 message and in accordance with the target cell configuration.

In some examples, the target cell configuration includes a random access configuration, a configured grant, or both, that indicates a set of resources for communicating with the candidate cell. In some examples, performing the handover procedure from the serving cell to the candidate cell includes communicating with the candidate cell via the set of resources.

In some examples, the first L3 message includes a first RRC reconfiguration message. In some examples, the second L3 message includes a second RRC reconfiguration message.

In some examples, to support communicating with the candidate cell in accordance with the early synchronization information, the random access manager 1045 may be configured to cause the UE 115 to perform a random access procedure with the candidate cell in accordance with the early synchronization information and prior to receiving the handover command.

In some examples, the measurement manager 1050 may be configured to cause the UE 115 to perform one or more measurements for signals received from the candidate cell based on communicating with the candidate cell in accordance with the early synchronization information. In some examples, the measurement report manager 1055 may be configured to cause the UE 115 to transmit, to the serving cell, a measurement report indicating the one or more measurements, where the second L3 message is received based on transmitting the measurement report.

In some examples, to support communicating with the candidate cell in accordance with the early synchronization information, the TA manager 1060 may be configured to cause the UE 115 to receive, from the candidate cell, a TA value for communicating with the candidate cell. In some examples, to support communicating with the candidate cell in accordance with the early synchronization information, the candidate cell communication manager 1030 may be configured to cause the UE 115 to communicate with the candidate cell in accordance with the TA value and based on performing the handover procedure.

In some examples, the downlink timing manager 1065 may be configured to cause the UE 115 to determine a first downlink timing value for the candidate cell based on communicating with the candidate cell in accordance with the early synchronization information. In some examples, the TA manager 1060 may be configured to cause the UE 115 to determine a TA value for the candidate cell based on the first downlink timing value for the candidate cell, a second downlink timing value for the serving cell, and an uplink timing value for the serving cell. In some examples, the candidate cell communication manager 1030 may be configured to cause the UE 115 to communicate with the candidate cell in accordance with the TA value and based on performing the handover procedure.

In some examples, the TA manager 1060 may be configured to cause the UE 115 to receive an indication of a TA value for the candidate cell via the second L3 message. In some examples, the candidate cell communication manager 1030 may be configured to cause the UE 115 to communicate with the candidate cell in accordance with the TA value and based on performing the handover procedure.

In some examples, the TA manager 1060 may be configured to cause the UE 115 to receive a first indication of a TA value for the candidate cell via the first L3 message. In some examples, the TA manager 1060 may be configured to cause the UE 115 to receive a second indication of the TA value for the candidate cell via the second L3 message. In some examples, the TA manager 1060 may be configured to cause the UE 115 to determine the TA value to use for communications with the candidate cell based on the first indication of the TA value, the second indication of the TA value, or both. In some examples, the candidate cell communication manager 1030 may be configured to cause the UE 115 to communicate with the candidate cell in accordance with the determined TA value and based on performing the handover procedure.

A processing system 1020 may include or be a component of one or more chips, systems-on-chips (SoCs), chipsets, packages, components, or devices that individually or collectively constitute or include a processing system. A processing system 1020 may interface with other components of a processing system 1020. For example, operations described with reference to a processing system 1020, or various components thereof, may be performed by or with other such components, including a receiver, a transmitter, a transceiver, a modem, a user interface, a modulator/demodulator, an encoder/decoder, or any combination thereof (such as of the processing system 1020, coupled with the processing system 1020, of a processing system 1020).

By including or configuring a processing system 1020 for operation in a processing system 1020 as described herein, the processing system 1020 may support techniques for improved communication reliability, reduced latency, more efficient utilization of communication resources, and improved coordination between devices.

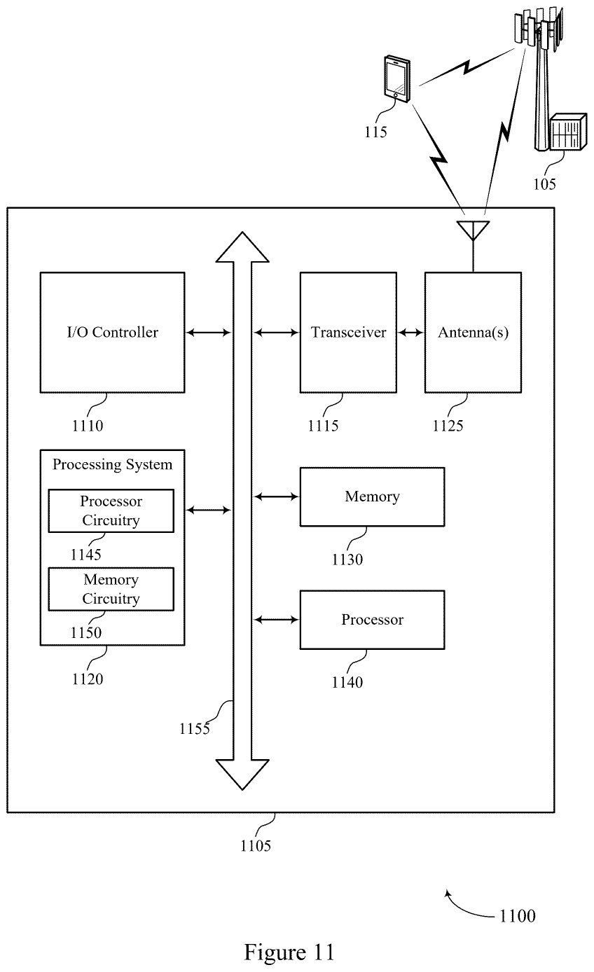

FIG. 11 shows an example of a system 1100 including a device 1105 that supports early-synchronization techniques for L3 handover procedures. The device 1105 may be an example of or include components of UE 115. The device 1105 may communicate (such as wirelessly) with one or more other devices (such as network entities 105, UEs 115). The device 1105 may include components for transmitting and receiving communication, which may include a processing system 1120, an input/output (I/O) controller, such as an I/O controller 1110, a transceiver 1115, antenna(s) 1125, a memory 1130, and a processor 1140. Components of the device 1105 may be coupled (such as operatively, communicatively, functionally, electronically, electrically, in electronic communication) a bus 1155.

The transceiver 1115 may support bi-directional communication via antenna(s) 1125, and may support transmission operations, reception operations, or both, as described herein. The transceiver 1115 may implement functionality of a modem (such as a wireless modem) and may include one or more RF chains. An RF chain may include one or more filters, mixers, oscillators, amplifiers, analog-to-digital converters (ADCs), and other components that convert between an analog signal (such as for transmission or reception via an air interface) and a digital signal (such as for digital processing at the device 1105). The transceiver 1115 may modulate symbols and provide the modulated symbols to antenna(s) 1125 for transmission, and demodulate symbols from signals received using antenna(s) 1125.

The processor 1140 may be a general-purpose processing component that supports various operations (such as applications) of the device 1105. The memory 1130 may be a general-purpose storage component that stores code executable by the processor 1140. Such code may include instructions that, when executed by the processor 1140, cause the device 1105 to perform various functions (such as to support an application of the device 1105). The I/O controller 1110 may manage inputs and outputs for the device 1105, may manage peripherals not integrated into the device 1105, or may represent a physical connection (such as port) to an external peripheral. The processor 1140 may interact with a modem, a keyboard, a mouse, a touchscreen, or other device (such as via I/O controller 1110). In some implementations, a user may interact with the device 1105 via the I/O controller 1110 or via hardware components controlled by the I/O controller 1110.

The processing system 1120 may be an example of a processing system 140 or a processing system 1020. For example, the processing system 1120 may include processor circuitry 1145 and memory circuitry 1150 that stores code, and may be configured to cause the device 1105 to perform operations that support early-synchronization techniques for L3 handover procedures. Although the processing system 1120 is illustrated as a separate component, which may involve a separate chip, chipset, or other module, in some implementations, one or more functions described with reference to the processing system 1120 may be supported by or performed by a transceiver 1115, antenna(s) 1125, a processor 1140, memory 1130, or any combination thereof, such that a processing system 1120 may include one or more of a transceiver 1115, antenna(s) 1125, a processor 1140, memory 1130, or any combination thereof.

By including or configuring the processing system 1120 for operation in the device 1105 as described herein, may support techniques for improved communication reliability, reduced latency, more efficient utilization of communication resources, and improved coordination between devices.

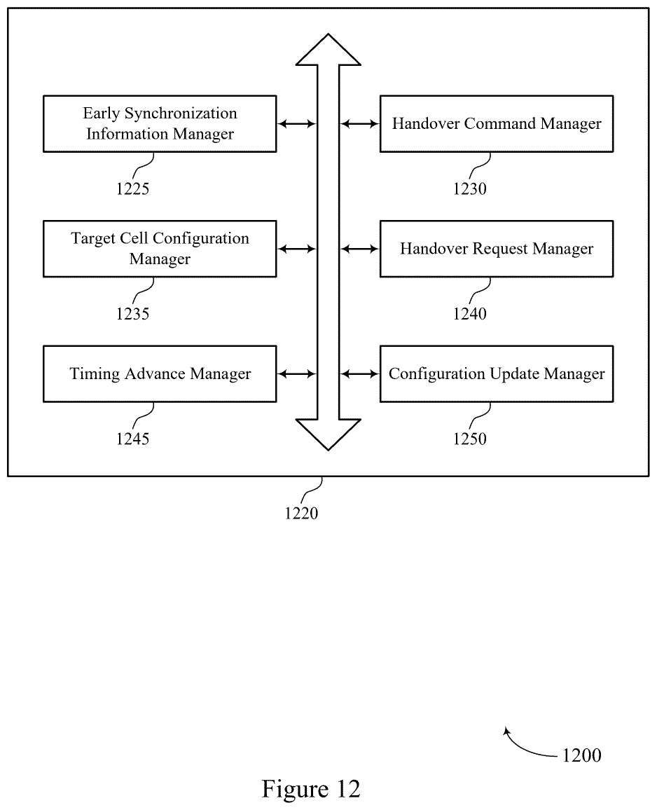

FIG. 12 shows an example 1200 of a processing system 1220 that supports early-synchronization techniques for L3 handover procedures. A processing system 1220 may be an example of a processing system 145 (such as network entity 105) and may include an early synchronization information manager 1225, a handover command manager 1230, a target cell configuration manager 1235, a handover request manager 1240, a TA manager 1245, a configuration update manager 1250, or any combination thereof. A processing system 1220, or various component thereof, may be an example of means for performing (such as a means for causing a network entity 105 to perform) various techniques described herein.

The early synchronization information manager 1225 may be configured to cause the network entity 105 to obtain, from a candidate cell, a message indicating early synchronization information for the candidate cell, the early synchronization information including a random access configuration for communications with the candidate cell, a RRC configuration for the candidate cell, a TCI state for communications with the candidate cell, or any combination thereof. In some examples, the early synchronization information manager 1225 may be configured to cause the network entity 105 to output, to a UE, a first L3 message including the early synchronization information. The handover command manager 1230 may be configured to cause the network entity 105 to output, to the UE, a second L3 message including a handover command for the UE to perform a handover procedure from the serving cell to the candidate cell, the second L3 message further including a target cell configuration for communicating with the candidate cell.

In some examples, the handover request manager 1240 may be configured to cause the network entity 105 to output a handover request message to the candidate cell, the handover request message including a request for the early synchronization information, where the message indicating the early synchronization information is obtained in response to the handover request message.

In some examples, the target cell configuration manager 1235 may be configured to cause the network entity 105 to output, via the handover request message, a second request for the target cell configuration. In some examples, the target cell configuration manager 1235 may be configured to cause the network entity 105 to obtain a second message indicating the target cell configuration from the candidate cell in response to the second request, where the first L3 message is outputted based on obtaining the message indicating early synchronization information, the second message indicating the target cell configuration, or both, from the candidate cell.

In some examples, the configuration update manager 1250 may be configured to cause the network entity 105 to output, to the candidate cell, a configuration update request for updating the target cell configuration. In some examples, the configuration update manager 1250 may be configured to cause the network entity 105 to obtain, from the candidate cell in response to the configuration update request, a configuration update for updating the target cell configuration for the candidate cell, where the second L3 message including the target cell configuration is outputted based on obtaining the configuration update.

In some examples, the target cell configuration includes a random access configuration, a configured grant, or both, that indicates a set of resources for communicating with the candidate cell.

In some examples, the first L3 message includes a first RRC reconfiguration message. In some examples, the second L3 message includes a second RRC reconfiguration message.

In some examples, the TA manager 1245 may be configured to cause the network entity 105 to output, to the UE, an indication of a TA value for the candidate cell via the second L3 message.

In some examples, the TA manager 1245 may be configured to cause the network entity 105 to obtain the TA value for the candidate cell from the candidate cell, where the indication of the TA value is outputted to the UE based on obtaining the TA value from the candidate cell.

In some examples, the TA manager 1245 may be configured to cause the network entity 105 to obtain a default TA value for the candidate cell via the message from the candidate cell. In some examples, the TA manager 1245 may be configured to cause the network entity 105 to obtain, from the candidate cell and based on outputting the first L3 message, an update to the default TA value. In some examples, the TA manager 1245 may be configured to cause the network entity 105 to output, to the UE, an indication of a TA value for the candidate cell based on obtaining the update from the candidate cell.

In some examples, the early synchronization information manager 1225 may be configured to cause the network entity 105 to output, to a candidate cell, a first request for early synchronization information for the candidate cell. In some examples, the early synchronization information manager 1225 may be configured to cause the network entity 105 to obtain, from the candidate cell in response to the first request, a first message indicating the early synchronization information for the candidate cell, the early synchronization information including a random access configuration for communications with the candidate cell, a RRC configuration for the candidate cell, a TCI state for communications with the candidate cell, or any combination thereof. In some examples, the early synchronization information manager 1225 may be configured to cause the network entity 105 to output, to a UE, a first L3 message including the early synchronization information. The target cell configuration manager 1235 may be configured to cause the network entity 105 to output, to the candidate cell, a second request for a target cell configuration for communications with the candidate cell. In some examples, the target cell configuration manager 1235 may be configured to cause the network entity 105 to obtain, from the candidate cell in response to the second request, a second message indicating the target cell configuration for the candidate cell. In some examples, the handover command manager 1230 may be configured to cause the network entity 105 to output, to the UE, a second L3 message including a handover command for the UE to perform a handover procedure from the serving cell to the candidate cell, the second L3 message further including the target cell configuration for communicating with the candidate cell.

In some examples, the target cell configuration includes a random access configuration, a configured grant, or both, that indicates a set of resources for communicating with the candidate cell.

In some examples, the first L3 message includes a first RRC reconfiguration message. In some examples, the second L3 message includes a second RRC reconfiguration message.

In some examples, the TA manager 1245 may be configured to cause the network entity 105 to output, to the UE, an indication of a TA value for the candidate cell via the second L3 message.

In some examples, the TA manager 1245 may be configured to cause the network entity 105 to obtain the TA value for the candidate cell from the candidate cell, where the indication of the TA value is outputted to the UE based on obtaining the TA value from the candidate cell.

A processing system 1220 may include or be an example of one or more chips, SoCs, chipsets, packages, components, or devices that individually or collectively constitute or include a processing system. A processing system 1220 may interface with other components of a network entity 105. For example, operations described with reference to a processing system 1220, or various components thereof, may be performed by or with other such components, including a receiver, a transmitter, a transceiver, a modem, a user interface, a modulator/demodulator, an encoder/decoder, or any combination thereof (such as of the processing system 1220, coupled with the processing system 1220, of a network entity 105). Operations described herein with reference to the processing system 1220, or various components thereof, may be performed by or with other such components, including a CU 160, a DU 165, an RU 170, or any combination thereof. Each of one or more of any of such components, or subcomponents thereof (such as one or more processors, one or more memories), may communicate, directly or indirectly, with one another. The communication may include communication within a protocol layer of a protocol stack, communication associated with a logical channel of a protocol stack (such as between protocol layers of a protocol stack, within a device, component, or virtualized component associated with a network entity 105, between devices, components, or virtualized components associated with a network entity 105), or any combination thereof.

By including or configuring a processing system 1220 for operation in a processing system 1220 as described herein, the processing system 1220 may support techniques for improved communication reliability, reduced latency, more efficient utilization of communication resources, and improved coordination between devices.

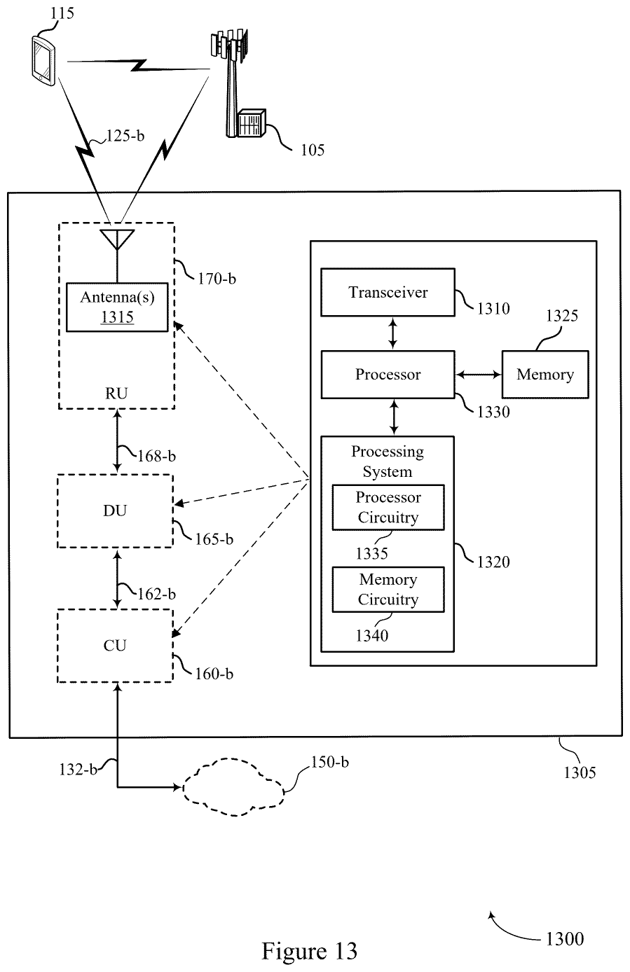

FIG. 13 shows an example of a system 1300 including a device 1305 that supports early-synchronization techniques for L3 handover procedures. The device 1305 may communicate (such as via one or more wired interfaces or one or more wireless interfaces) with other network devices or network equipment such as a core network 150-b, other network entities 105, UEs 115, or any combination thereof. The device 1305 may include components for transmitting and receiving communication, which may include a processing system 1320, a transceiver 1310, antenna(s) 1315, a memory 1325, and a processor 1330. Components of the device 1305 may be coupled (such as operatively, communicatively, functionally, electronically, electrically, in electronic communication) via one or more interfaces.

The transceiver 1310 may communicate bi-directionally with another transceiver via wired or wireless links, and may support transmission operations, reception operations, or both, as described herein. The transceiver 1310 may include a modem to modulate and demodulate signals, to provide the modulated signals for transmission (such as via antenna(s) 1315, via a wired interface), and to demodulate received signals (such as received via antenna(s) 1315, received via a wired interface). The transceiver 1310 may be operable to support communication via one or more communication links (such as a communication link 125-b, a backhaul link 132-b, a midhaul link 162-b, fronthaul link 168-b).

The processor 1330 may be a general-purpose processing component that supports various operations (such as applications) of the device 1305. The memory 1325 may be a general-purpose storage component that stores code executable by the processor 1330. Such code may include instructions that, when executed by the processor 1330, cause the device 1305 to perform various functions (such as to support an application of the device 1305).

For examples in which the device 1305 is a network entity 105 in a disaggregated architecture, one or more components of the device 1305 may be located at one or more of a CU 160-b, a DU 165-b, or an RU 170-b, one or more of which may include aspects of the processing system 1320, the processor 1330, the memory 1325, or the transceiver 1310. Functions of the device 1305 may be performed at different components or an operation may be divided between different components (such as different functions being supported by aspects of the CU 160-b, the DU 165-b, or the RU 170-b, the transceiver 1310, the processor 1330, the memory 1325, the processing system 1320, or any combination thereof). For example, the processing system 1320 may be a component of one or more of the CU 160-b, the DU 165-b, or the RU 170-b. In some examples, interfaces between components of device 1305 (such as CU 160-b, DU 165-b, RU 170-b) may support communication at a protocol layer or between protocol layers of a protocol stack.

In some examples, the processing system 1320 may manage aspects of communication with the core network 150-b (such as via a backhaul link 132). For example, the processing system 1320 may manage the transfer of data communication for UEs 115 with a gateway of the core network 150-b. In some examples, the processing system 1320 may manage communication with one or more other network entities 105 and may include a controller or scheduler for controlling communication with UEs 115 (such as in cooperation with the one or more other network entities 105). In some examples, the processing system 1320 may support an interface (such as X2 interface, Xn interface) to provide communication between network entities 105.

The processing system 1320 may be an example of a processing system 145 or a processing system 1220. For example, the processing system 1320 may include processor circuitry 1335 and memory circuitry 1340 that stores code, and the processing system 1320 may be configured to cause the device 1305 to perform operations that support early-synchronization techniques for L3 handover procedures. Although the processing system 1320 is illustrated as a separate component, which may involve a separate chip, chipset, or other module, in some implementations, one or more functions described with reference to the processing system 1320 may be supported by or performed by a transceiver 1310, antenna(s) 1315, a processor 1330, memory 1325, or any combination thereof, such that a processing system 1320 may include one or more of a transceiver 1310, antenna(s) 1315, a processor 1330, memory 1325, or any combination thereof. Further, processor circuitry 1335 and memory circuitry 1340 each may be implemented at the device 1305 in accordance with an aggregated architecture, or the processor circuitry 1335 and the memory circuitry 1340 may be implemented at one or more of a CU 160-b, a DU 165-b, or an RU 170-b in accordance with a disaggregated architecture.

By including or configuring the processing system 1320 for operation in the device 1305 as described herein, may support techniques for improved communication reliability, reduced latency, reduced power consumption, more efficient utilization of communication resources, and improved coordination between devices.

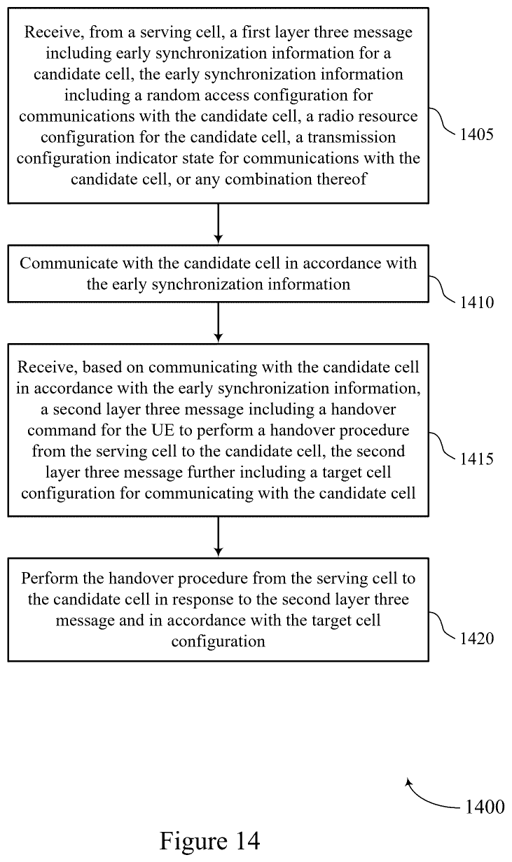

FIG. 14 shows an example of a method 1400 that supports early-synchronization techniques for L3 handover procedures. Operations of the method 1400 may be performed by a UE or its components (such as using a processing system configured to cause the UE 115 to perform one or more of the operations) as described herein.

At 1405, the method may include receiving, from a serving cell, a first L3 message including early synchronization information for a candidate cell, the early synchronization information including a random access configuration for communications with the candidate cell, a RRC configuration for the candidate cell, a TCI state for communications with the candidate cell, or any combination thereof. In some examples, aspects of the operations of 1405 may be performed by an early synchronization information manager 1025.

At 1410, the method may include communicating with the candidate cell in accordance with the early synchronization information. In some examples, aspects of the operations of 1410 may be performed by a candidate cell communication manager 1030.

At 1415, the method may include receiving, based on communicating with the candidate cell in accordance with the early synchronization information, a second L3 message including a handover command for the UE to perform a handover procedure from the serving cell to the candidate cell, the second L3 message further including a target cell configuration for communicating with the candidate cell. In some examples, aspects of the operations of 1415 may be performed by a handover command manager 1035.

At 1420, the method may include performing the handover procedure from the serving cell to the candidate cell in response to the second L3 message and in accordance with the target cell configuration. In some examples, aspects of the operations of 1420 may be performed by a handover procedure manager 1040.

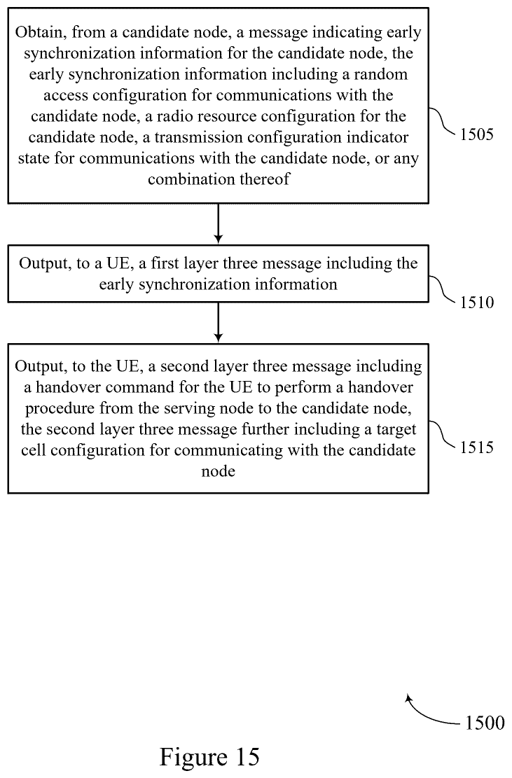

FIG. 15 shows an example of a method 1500 that supports early-synchronization techniques for L3 handover procedures. Operations of the method 1500 may be performed by a network entity 105 (e.g., network node) or its components (such as using a processing system configured to cause the network entity to perform one or more operations) as described herein.

At 1505, the method may include obtaining, from a candidate node, a message indicating early synchronization information for the candidate node, the early synchronization information including a random access configuration for communications with the candidate node, a RRC configuration for the candidate node, a TCI state for communications with the candidate node, or any combination thereof. In some examples, aspects of the operations of 1505 may be performed by an early synchronization information manager 1225.

At 1510, the method may include outputting, to a UE, a first L3 message including the early synchronization information. In some examples, aspects of the operations of 1510 may be performed by an early synchronization information manager 1225.

At 1515, the method may include outputting, to the UE, a second L3 message including a handover command for the UE to perform a handover procedure from the serving node to the candidate node, the second L3 message further including a target cell configuration for communicating with the candidate node. In some examples, aspects of the operations of 1515 may be performed by a handover command manager 1230.

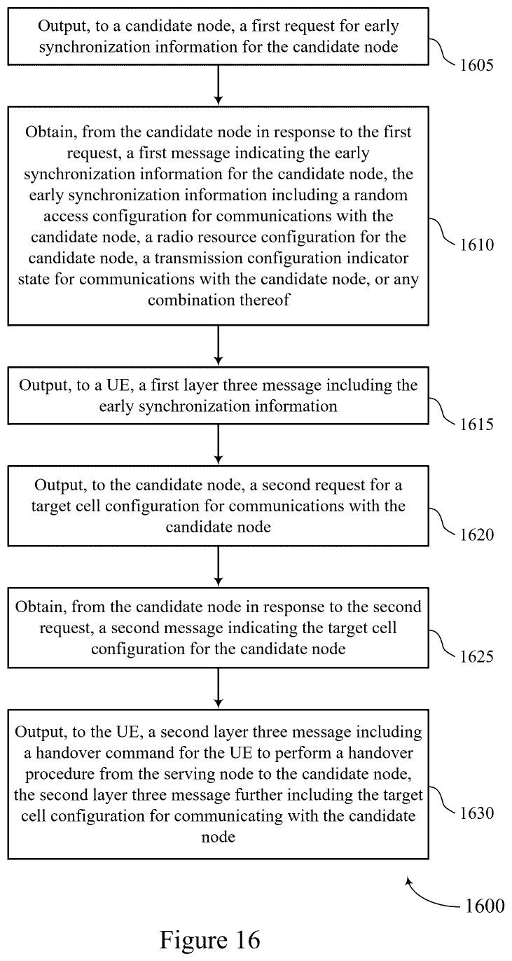

FIG. 16 shows an example of a method 1600 that supports early-synchronization techniques for L3 handover procedures. Operations of the method 1600 may be performed by a network entity 105 or its components (such as using a processing system configured to cause the network entity to perform one or more operations) as described herein.

At 1605, the method may include outputting, to a candidate node, a first request for early synchronization information for the candidate node. In some examples, aspects of the operations of 1605 may be performed by an early synchronization information manager 1225.

At 1610, the method may include obtaining, from the candidate node in response to the first request, a first message indicating the early synchronization information for the candidate node, the early synchronization information including a random access configuration for communications with the candidate node, a RRC configuration for the candidate node, a TCI state for communications with the candidate node, or any combination thereof. In some examples, aspects of the operations of 1610 may be performed by an early synchronization information manager 1225.

At 1615, the method may include outputting, to a UE, a first L3 message including the early synchronization information. In some examples, aspects of the operations of 1615 may be performed by an early synchronization information manager 1225.

At 1620, the method may include outputting, to the candidate node, a second request for a target cell configuration for communications with the candidate node. In some examples, aspects of the operations of 1620 may be performed by a target cell configuration manager 1235.

At 1625, the method may include obtaining, from the candidate node in response to the second request, a second message indicating the target cell configuration for the candidate node. In some examples, aspects of the operations of 1625 may be performed by a target cell configuration manager 1235.

At 1630, the method may include outputting, to the UE, a second L3 message including a handover command for the UE to perform a handover procedure from the serving node to the candidate node, the second L3 message further including the target cell configuration for communicating with the candidate node. In some examples, aspects of the operations of 1630 may be performed by a handover command manager 1230.

Implementation examples are described in the following numbered clauses:

Aspect 1: A method for wireless communications at a UE, comprising: receiving, from a serving cell, a first L3 message comprising early synchronization information for a candidate cell, the early synchronization information comprising a random access configuration for communications with the candidate cell, a RRC configuration for the candidate cell, a TCI state for communications with the candidate cell, or any combination thereof; communicating with the candidate cell in accordance with the early synchronization information; receiving, based at least in part on communicating with the candidate cell in accordance with the early synchronization information, a second L3 message comprising a handover command for the UE to perform a handover procedure from the serving cell to the candidate cell, the second L3 message further comprising a target cell configuration for communicating with the candidate cell; and performing the handover procedure from the serving cell to the candidate cell in response to the second L3 message and in accordance with the target cell configuration.

Aspect 2: The method of aspect 1, wherein the target cell configuration comprises a random access configuration, a configured grant, or both, that indicates a set of resources for communicating with the candidate cell, performing the handover procedure from the serving cell to the candidate cell comprises communicating with the candidate cell via the set of resources.

Aspect 3: The method of any of aspects 1 through 2, wherein the first L3 message comprises a first RRC reconfiguration message, and the second L3 message comprises a second RRC reconfiguration message.

Aspect 4: The method of any of aspects 1 through 3, wherein communicating with the candidate cell in accordance with the early synchronization information comprises: performing a random access procedure with the candidate cell in accordance with the early synchronization information and prior to receiving the handover command.

Aspect 5: The method of any of aspects 1 through 4, further comprising: performing one or more measurements for signals received from the candidate cell based at least in part on communicating with the candidate cell in accordance with the early synchronization information; and transmitting, to the serving cell, a measurement report indicating the one or more measurements, wherein the second L3 message is received based at least in part on transmitting the measurement report.

Aspect 6: The method of any of aspects 1 through 5, wherein communicating with the candidate cell in accordance with the early synchronization information comprises: receiving, from the candidate cell, a TA value for communicating with the candidate cell; and communicating with the candidate cell in accordance with the TA value and based at least in part on performing the handover procedure.

Aspect 7: The method of any of aspects 1 through 6, further comprising: determining a first downlink timing value for the candidate cell based at least in part on communicating with the candidate cell in accordance with the early synchronization information; determining a TA value for the candidate cell based at least in part on the first downlink timing value for the candidate cell, a second downlink timing value for the serving cell, and an uplink timing value for the serving cell; and communicating with the candidate cell in accordance with the TA value and based at least in part on performing the handover procedure.

Aspect 8: The method of any of aspects 1 through 7, further comprising: receiving an indication of a TA value for the candidate cell via the second L3 message; and communicating with the candidate cell in accordance with the TA value and based at least in part on performing the handover procedure.

Aspect 9: The method of any of aspects 1 through 8, further comprising: receiving a first indication of a TA value for the candidate cell via the first L3 message; receiving a second indication of the TA value for the candidate cell via the second L3 message; determining the TA value to use for communications with the candidate cell based at least in part on the first indication of the TA value, the second indication of the TA value, or both; and communicating with the candidate cell in accordance with the determined TA value and based at least in part on performing the handover procedure.

Aspect 10: A method for wireless communications at a serving cell, comprising: obtaining, from a candidate cell, a message indicating early synchronization information for the candidate cell, the early synchronization information comprising a random access configuration for communications with the candidate cell, a RRC configuration for the candidate cell, a TCI state for communications with the candidate cell, or any combination thereof; outputting, to a UE, a first L3 message comprising the early synchronization information; and outputting, to the UE, a second L3 message comprising a handover command for the UE to perform a handover procedure from the serving cell to the candidate cell, the second L3 message further comprising a target cell configuration for communicating with the candidate cell.

Aspect 11: The method of aspect 10, further comprising: outputting a handover request message to the candidate cell, the handover request message comprising a request for the early synchronization information, wherein the message indicating the early synchronization information is obtained in response to the handover request message.

Aspect 12: The method of aspect 11, further comprising: outputting, via the handover request message, a second request for the target cell configuration; and obtaining a second message indicating the target cell configuration from the candidate cell in response to the second request, wherein the first L3 message is outputted based at least in part on obtaining the message indicating early synchronization information, the second message indicating the target cell configuration, or both, from the candidate cell.

Aspect 13: The method of aspect 12, further comprising: outputting, to the candidate cell, a configuration update request for updating the target cell configuration; and obtaining, from the candidate cell in response to the configuration update request, a configuration update for updating the target cell configuration for the candidate cell, wherein the second L3 message comprising the target cell configuration is outputted based at least in part on obtaining the configuration update.

Aspect 14: The method of any of aspects 10 through 13, wherein the target cell configuration comprises a random access configuration, a configured grant, or both, that indicates a set of resources for communicating with the candidate cell.

Aspect 15: The method of any of aspects 10 through 14, wherein the first L3 message comprises a first RRC reconfiguration message, and the second L3 message comprises a second RRC reconfiguration message.

Aspect 16: The method of any of aspects 10 through 15, further comprising: outputting, to the UE, an indication of a TA value for the candidate cell via the second L3 message.

Aspect 17: The method of aspect 16, further comprising: obtaining the TA value for the candidate cell from the candidate cell, wherein the indication of the TA value is outputted to the UE based at least in part on obtaining the TA value from the candidate cell.

Aspect 18: The method of any of aspects 10 through 17, further comprising: obtaining a default TA value for the candidate cell via the message from the candidate cell; obtaining, from the candidate cell and based at least in part on outputting the first L3 message, an update to the default TA value; and outputting, to the UE, an indication of a TA value for the candidate cell based at least in part on obtaining the update from the candidate cell.

Aspect 19: A method for wireless communications at a serving cell, comprising: outputting, to a candidate cell, a first request for early synchronization information for the candidate cell; obtaining, from the candidate cell in response to the first request, a first message indicating the early synchronization information for the candidate cell, the early synchronization information comprising a random access configuration for communications with the candidate cell, a RRC configuration for the candidate cell, a TCI state for communications with the candidate cell, or any combination thereof; outputting, to a UE, a first L3 message comprising the early synchronization information; outputting, to the candidate cell, a second request for a target cell configuration for communications with the candidate cell; obtaining, from the candidate cell in response to the second request, a second message indicating the target cell configuration for the candidate cell; and outputting, to the UE, a second L3 message comprising a handover command for the UE to perform a handover procedure from the serving cell to the candidate cell, the second L3 message further comprising the target cell configuration for communicating with the candidate cell.

Aspect 20: The method of aspect 19, wherein the target cell configuration comprises a random access configuration, a configured grant, or both, that indicates a set of resources for communicating with the candidate cell.

Aspect 21: The method of any of aspects 19 through 20, wherein the first L3 message comprises a first RRC reconfiguration message, and the second L3 message comprises a second RRC reconfiguration message.

Aspect 22: The method of any of aspects 19 through 21, further comprising: outputting, to the UE, an indication of a TA value for the candidate cell via the second L3 message.

Aspect 23: The method of aspect 22, further comprising: obtaining the TA value for the candidate cell from the candidate cell, wherein the indication of the TA value is outputted to the UE based at least in part on obtaining the TA value from the candidate cell.

Aspect 24: A UE comprising a processing system that includes processor circuitry and memory circuitry that stores code, the processing system configured to cause the UE to perform a method of any of aspects 1 through 9.

Aspect 25: A UE comprising at least one means for performing a method of any of aspects 1 through 9.

Aspect 26: A non-transitory computer-readable medium storing code the code comprising instructions executable by one or more processors to perform a method of any of aspects 1 through 9.

Aspect 27: A serving cell comprising a processing system that includes processor circuitry and memory circuitry that stores code, the processing system configured to cause the serving cell to perform a method of any of aspects 10 through 18.

Aspect 28: A serving cell comprising at least one means for performing a method of any of aspects 10 through 18.

Aspect 29: A non-transitory computer-readable medium storing code the code comprising instructions executable by one or more processors to perform a method of any of aspects 10 through 18.

Aspect 30: A serving cell comprising a processing system that includes processor circuitry and memory circuitry that stores code, the processing system configured to cause the serving cell to perform a method of any of aspects 19 through 23.

Aspect 31: A serving cell comprising at least one means for performing a method of any of aspects 19 through 23.

Aspect 32: A non-transitory computer-readable medium storing code the code comprising instructions executable by one or more processors to perform a method of any of aspects 19 through 23.

It should be noted that methods described herein describe possible implementations. Other implementations in accordance with the described techniques are possible, including implementations in which operations are rearranged or otherwise modified relative to the described methods. Further, aspects from two or more of the described methods may be combined.

Although aspects of 5G or 6G systems may be described for purposes of example and corresponding terminology may be used in the description, the techniques described herein are applicable beyond 5G, or 6G networks. For example, the described techniques may be applicable to other communication systems such as Institute of Electrical and Electronics Engineers (IEEE) 802.11 (Wi-Fi), IEEE 802.20, Flash-OFDM, or other systems and radio technologies not explicitly mentioned herein.

As used herein, a processing system (such as a processing system 140, a processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform functions or operations described herein. A group of processors collectively configurable or configured to cause a device to perform a set of functions may include a first processor configured to cause the device to perform a first function of the set and a second processor configured to cause the device to perform a second function of the set. In some other examples, each of a group of processors may be configured to cause a device to perform a same set of functions.

As used herein, a processing system (such as a processing system 140, a processing system 145) also includes memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (such as operatively, communicatively, electronically, electrically) with one or more processors of the processor circuitry and may individually or collectively store processor-executable code or instructions (such as software) that, when executed by one or more of the processors, may cause a device (such as configure the device, using one or more of the processors) to perform functions or operations described herein. Additionally, or alternatively, in some examples, one or more of the processors may be configured to cause a device to perform functions or operations described herein without requiring configuration by software. As used herein, “software” shall be construed to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

As used herein, a processing system (such as a processing system 140, a processing system 145) may include or be coupled with one or more modems (such as a cellular modem, a 5G-compliant modem, a 6G-compliant modem). In some examples, one or more processors of a processing system may include or implement one or more of the modems. A processing system also may include or be coupled with multiple radios (collectively “the radio”), multiple RF chains, or multiple transceivers, each of which may in turn be coupled with one or more of multiple antennas. In some examples, one or more processors of a processing system may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by processor circuitry).

As described herein, being “configured to,” being “configurable to,” and being “operable to” may be used interchangeably and may be associated with a capability, when executing code (such as processor-executable code, instructions) stored in memory circuitry (such as a non-transitory computer-readable medium, of the memory circuitry, storing code for wireless communication that is executable by a processing system) or otherwise, to perform one or more of the functions described herein.

As used herein, the term “determine” or “determining” can encompass one or more of a variety of actions. For example, “determining” can include one or more of calculating, computing, processing, deriving, detecting, estimating, looking up, inferring, ascertaining, measuring, resolving, selecting, obtaining, identifying, interpreting, demodulating, decoding, reading, establishing, forming, or generating, among other examples. In some such examples, determining can involve a processing system performing some type of calculating, computing, deriving, estimating, inferring, ascertaining, resolving, predicting, or other processing to obtain one or more numerical values, sets, elements, or other information or results. In some such examples, determining can involve a processing system identifying, looking up, investigating or otherwise obtaining some type of value, set, element, or other information or result from a table, data structure, database, or an implementation of memory, such as from a larger set of values, sets, or elements or other information or results. In some such examples, determining can involve a processing system identifying, interpreting, demodulating, decoding, detecting, reading, or otherwise obtaining some type of value, set, element, or other information or result signaled in, for example, a received wireless signal. In some such examples, determining can involve a processing system performing a measurement, such as on a received signal.

As used herein, a phrase referring to “at least one of” or “one or more of” a list of items refers to any combination of those items, including single members. For example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Thus, the terms “a,” “at least one,” “one or more,” and “at least one of one or more” may be interchangeable. For instance, for a claim that refers to “a” component performing one or more functions, each of the individual functions may be performed by a single component or by any combination of multiple components, and subsequent reference to a component introduced with the article “a” using the term “the” may refer to any or all of the single or multiple components. Thus, a component introduced with the article “a” may be understood to mean “one or more” components, and referring to “the” component subsequently in the claims may be understood to be equivalent to referring to “at least one of the one or more” components. Additionally, as used herein, a “set” can refer to one or more items, and a “subset” can refer to a whole set or less than the whole set, but not an empty set. Additionally, as used herein, the term “or” is intended to be interpreted in the inclusive sense, such as when referring to a series, and may be used interchangeably with the term “and/or,” unless otherwise explicitly indicated (for example, if used in conjunction with “either” or “only one of”). For example, “a or b” may include a only, b only, or a combination of a and b.

The disclosure is provided to enable a person having ordinary skill in the art to implement the described techniques. Modifications to the disclosure will be apparent to a person having ordinary skill in the art, and the techniques disclosed herein may be applied with other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
a processing system that includes processor circuitry and memory circuitry that stores code, the processing system configured to cause the UE to:
receive, from a serving cell, a first layer three message comprising early synchronization information for a candidate cell, the early synchronization information comprising a random access configuration for communications with the candidate cell, a radio resource control configuration for the candidate cell, a transmission configuration indicator state for communications with the candidate cell, or any combination thereof;
communicate with the candidate cell in accordance with the early synchronization information;
receive, based at least in part on communicating with the candidate cell in accordance with the early synchronization information, a second layer three message comprising a handover command for the UE to perform a handover procedure from the serving cell to the candidate cell, the second layer three message further comprising a target cell configuration for communicating with the candidate cell; and
perform the handover procedure from the serving cell to the candidate cell in response to the second layer three message and in accordance with the target cell configuration.

2. The UE of claim 1, wherein the target cell configuration comprises a random access configuration, a configured grant, or both, that indicates a set of resources for communicating with the candidate cell, wherein performing the handover procedure from the serving cell to the candidate cell comprises communicating with the candidate cell via the set of resources.

3. The UE of claim 1, wherein the first layer three message comprises a first radio resource control reconfiguration message, wherein, to communicate with the candidate cell in accordance with the early synchronization information, the processing system is configured to cause the UE to:
perform a random access procedure with the candidate cell in accordance with the early synchronization information and prior to receiving the handover command.

4. The UE of claim 1, wherein the processing system is further configured to cause the UE to:
perform one or more measurements for signals received from the candidate cell based at least in part on communicating with the candidate cell in accordance with the early synchronization information; and
transmit, to the serving cell, a measurement report indicating the one or more measurements, wherein the second layer three message is received based at least in part on transmitting the measurement report.

5. The UE of claim 1, wherein, to communicate with the candidate cell in accordance with the early synchronization information, the processing system is configured to cause the UE to:
receive, from the candidate cell, a timing advance value for communicating with the candidate cell; and
communicate with the candidate cell in accordance with the timing advance value and based at least in part on performing the handover procedure.

6. The UE of claim 1, wherein the processing system is further configured to cause the UE to:
determine a first downlink timing value for the candidate cell based at least in part on communicating with the candidate cell in accordance with the early synchronization information;
determine a timing advance value for the candidate cell based at least in part on the first downlink timing value for the candidate cell, a second downlink timing value for the serving cell, and an uplink timing value for the serving cell; and
communicate with the candidate cell in accordance with the timing advance value and based at least in part on performing the handover procedure.

7. The UE of claim 1, wherein the processing system is further configured to cause the UE to:
receive an indication of a timing advance value for the candidate cell via the second layer three message; and
communicate with the candidate cell in accordance with the timing advance value and based at least in part on performing the handover procedure.

8. The UE of claim 1, wherein the processing system is further configured to cause the UE to:
receive a first indication of a timing advance value for the candidate cell via the first layer three message;
receive a second indication of the timing advance value for the candidate cell;
determine the timing advance value to use for communications with the candidate cell based at least in part on the first indication of the timing advance value, the second indication of the timing advance value, or both; and
communicate with the candidate cell in accordance with the determined timing advance value and based at least in part on performing the handover procedure.

9. A serving node, comprising:
a processing system that includes processor circuitry and memory circuitry that stores code, the processing system configured to cause the serving node to:
obtain, from a candidate node, a message indicating early synchronization information for the candidate node, the early synchronization information comprising a random access configuration for communications with the candidate node, a radio resource control configuration for the candidate node, a transmission configuration indicator state for communications with the candidate node, or any combination thereof;
output, to a user equipment (UE), a first layer three message comprising the early synchronization information; and
output, to the UE, a second layer three message comprising a handover command for the UE to perform a handover procedure from the serving node to the candidate node, the second layer three message further comprising a target cell configuration for communicating with the candidate node.

10. The serving node of claim 9, wherein the processing system is further configured to cause the serving node to:
output a handover request message to the candidate node, the handover request message comprising a request for the early synchronization information, wherein the message indicating the early synchronization information is obtained in response to the handover request message.

11. The serving node of claim 10, wherein the processing system is further configured to cause the serving node to:
output, via the handover request message, a second request for the target cell configuration; and
obtain a second message indicating the target cell configuration from the candidate node in response to the second request, wherein the first layer three message is outputted based at least in part on obtaining the message indicating early synchronization information, the second message indicating the target cell configuration, or both, from the candidate node.

12. The serving node of claim 11, wherein the processing system is further configured to cause the serving node to:
output, to the candidate node, a configuration update request for updating the target cell configuration; and
obtain, from the candidate node in response to the configuration update request, a configuration update for updating the target cell configuration for the candidate node, wherein the second layer three message comprising the target cell configuration is outputted based at least in part on obtaining the configuration update.

13. The serving node of claim 9, wherein the target cell configuration comprises a random access configuration, a configured grant, or both, that indicates a set of resources for communicating with the candidate node.

14. The serving node of claim 9, wherein the processing system is further configured to cause the serving node to:
output, to the UE, an indication of a timing advance value for the candidate node via the second layer three message.

15. The serving node of claim 14, wherein the processing system is further configured to cause the serving node to:
obtain the timing advance value for the candidate node from the candidate node, wherein the indication of the timing advance value is outputted to the UE based at least in part on obtaining the timing advance value from the candidate node.

16. The serving node of claim 9, wherein the processing system is further configured to cause the serving node to:
obtain a default timing advance value for the candidate node via the message from the candidate node;
obtain, from the candidate node and based at least in part on outputting the first layer three message, an update to the default timing advance value; and
output, to the UE, an indication of a timing advance value for the candidate node based at least in part on obtaining the update from the candidate node.

17. A serving node, comprising:
a processing system that includes processor circuitry and memory circuitry that stores code, the processing system configured to cause the serving node to:
output, to a candidate node, a first request for early synchronization information for the candidate node;
obtain, from the candidate node in response to the first request, a first message indicating the early synchronization information for the candidate node, the early synchronization information comprising a random access configuration for communications with the candidate node, a radio resource control configuration for the candidate node, a transmission configuration indicator state for communications with the candidate node, or any combination thereof;
output, to a user equipment (UE), a first layer three message comprising the early synchronization information;
output, to the candidate node, a second request for a target cell configuration for communications with the candidate node;
obtain, from the candidate node in response to the second request, a second message indicating the target cell configuration for the candidate node; and
output, to the UE, a second layer three message comprising a handover command for the UE to perform a handover procedure from the serving node to the candidate node, the second layer three message further comprising the target cell configuration for communicating with the candidate node.

18. The serving node of claim 17, wherein the target cell configuration comprises a random access configuration, a configured grant, or both, that indicates a set of resources for communicating with the candidate node.

19. The serving node of claim 17, wherein the processing system is further configured to cause the serving node to:
output, to the UE, an indication of a timing advance value for the candidate node via the second layer three message.

20. The serving node of claim 19, wherein the processing system is further configured to cause the serving node to:
obtain the timing advance value for the candidate node from the candidate node, wherein the indication of the timing advance value is outputted to the UE based at least in part on obtaining the timing advance value from the candidate node.
